(19) United States
(12) Patent Application Publication
(10) Pub. No.: US 2025/0307585 A1
(43) Pub. Date: Oct. 2, 2025

(54) IMAGE FORMING DEVICE, IMAGE FORMING METHOD, IMAGE PROCESSING DEVICE, AND IMAGE PROCESSING METHOD

(71) Applicant: SEIKO EPSON CORPORATION, Tokyo (JP)

(72) Inventors: Toshiaki KAKUTANI, Shiojiri, Nagano (JP); Hirotaka MATSUNAGA, Matsumoto, Nagano (JP)

(21) Appl. No.: 19/089,068

(22) Filed: Mar. 25, 2025

(30) Foreign Application Priority Data
Mar. 27, 2024 (JP) 2024-050638

(51) Int. Cl. G06K 15/02; B41J 2/21; G06K 15/10

(52) U.S. Cl. CPC G06K 15/1881; B41J 2/2132; G06K 15/102

(57) ABSTRACT

An output image includes a first pixel group, and a second pixel group. A halftone processing unit that performs halftone processing on a original image causes an arrangement of pixels where dots are formed in the first pixel group to have a distribution having a first characteristic relating to dispersibility, and in the second pixel group to have a distribution having a second characteristic relating to dispersibility and causes the distribution according to the second characteristic not to be correlated with the distribution according to the first characteristic when the input tone value of the original image is equal to or higher than a intermediate value. Then, the on and off of the dot in the arrangement having the first characteristic in the first pixel group is determined, and the on and off of the dot in the arrangement having the second characteristic in the second pixel group is determined.

The present application is based on, and claims priority from JP Application Serial Number 2024-050638, filed Mar. 27, 2024, the disclosure of which is hereby incorporated by reference herein in its entirety.

### BACKGROUND

### 1. Technical Field

The present disclosure relates to a technique of image processing and image forming in which an original image expressed with multiple tones is processed into an output image expressed by a dot distribution.

### 2. Related Art

In a technique in which liquid droplets are ejected onto a print medium to perform printing, a tone is represented by a distribution of dots. Such a dot distribution is provided with a blue noise characteristic and a green noise characteristic to eliminate the unevenness in the dot distribution, thereby enhancing the image quality. In such formation of dots, a plurality of dot groups may be superimposed on each other in a predetermined area. For example, in bidirectional printing of a serial printer, a group of dots formed by a forward movement and a group of dots formed by a backward movement are superimposed on each other to form an image. Alternatively, in a large printer in which a plurality of print heads with a predetermined length are arranged, two print heads may be arranged in such a way that the end parts thereof overlap each other, and a group of dots formed by one print head and a group of dots formed by the other print head overlap each other.

When groups of dots are superimposed on each other to form an image, if the dot forming position for each group deviates from a normal position based on the design, the image quality is deteriorated significantly. In order to solve this problem, the applicant of the present application has proposed a technique of generating a dither mask that causes the drop in the image quality to fall within a predetermined range even when a shift in the dot forming position between groups occurs, and a technique of image processing, printing, or the like using the dither mask generation technique, such as JP-A-2007-245618 and JP-A-2013-103437.

JP-A-2007-245618 and JP-A-2013-103437 are examples of the related art.

This technique is excellent in achieving both a high speed of bidirectional printing or the like, and a dramatic improvement in the print quality, but needs further improvement in the following two points. The first point is that, when these techniques are employed, the drop in the image quality decreases in relation to the shift in the dot forming position between groups, and since the highest image quality is achieved when there is no shift whereas the image quality drops when there is a shift, this difference may be visually recognized as an unevenness. There may be a case where a difference in the image quality, particularly in the granularity, is generated between an area where all dots can be formed by one scan (an area where there is basically no shift in the arrangement of dots between groups) and an area where dots are formed by a plurality of scans (an area where there is a shift in the arrangement of dots formed by each scan), and this difference is visually recognized as an unevenness.

The other point is that it takes time and effort to generate a dither mask used when implementing these techniques. This is because, in order to achieve, by the dithering method, an arrangement of dots that results in a minor drop in the image quality even when there is a shift in the arrangement of dots between groups, not only each dither mask for determining the arrangement of dots for each group needs to be provided with the characteristics of blue noise and green noise, but also the arrangement of thresholds in the dither mask needs to be determined in such a way that an arrangement of dots formed by superimposing the arrangements of dots for the plurality of groups has similar characteristics. In order to arrange the thresholds while verifying the position of each threshold forming the dither mask and the dispersibility (spatial frequency) of the dots based on the arrangement one by one, the Fourier transform for finding the spatial frequency the of arrangement of dots and the evaluation thereof take the computation time and effort. In a systematic dithering method, a large dither mask of 64×256 is used to achieve high image quality, and therefore reducing such computation time and effort is significantly advantageous.

### SUMMARY

The present disclosure can be implemented in the aspects or application examples given below.

(1) One embodiment of the present disclosure is an image forming device that forms an output image corresponding to an original image. The image forming device includes: a halftone processing unit that determines an on and off of dot formation in accordance with an input tone value of the original image to be formed; and a dot forming unit that forms an output image including a plurality of pixels, with the dot, using a result of processing performed by the halftone processing unit, wherein the output image includes a first pixel group including a plurality of pixels whose positions in the output image are determined, and a second pixel group including a plurality of pixels arranged at different positions from the pixels of the first pixel group, the halftone processing unit causes an arrangement of pixels where dots are formed in the first pixel group to have a distribution having a first characteristic relating to dispersibility, causes an arrangement of pixels where dots are formed in the second pixel group to have a distribution having a second characteristic relating to dispersibility, and causes the distribution according second characteristic not to be correlated with the distribution according to the first characteristic when the input tone value of the original image is equal to or higher than a predetermined intermediate and value, the halftone processing unit determines the on and off of the dot in the arrangement having the first characteristic in the first pixel group, and determines the on and off of the dot in the arrangement having the second characteristic in the second pixel group.

(2) Another embodiment of the present disclosure is an image forming method of forming an output image based on a distribution of dots. In the image forming method, the output image includes a first pixel group including a plurality of pixels whose positions are determined in the output image, and a second pixel group including a plurality of pixels arranged at positions different from the pixels of the first pixel group. The image forming method includes, in halftone processing of determining an on and off of dot formation in accordance with an input tone value of the original image to be formed: causing an arrangement of pixels where dots are formed in the first pixel group to have a distribution having a first characteristic relating to dispersibility; causing an arrangement of pixels where dots are formed in the second pixel group to have a distribution having a second characteristic relating to dispersibility, and causing the distribution according to the second characteristic not to be correlated with the distribution according to the first characteristic when the input tone value of the original image is equal to or higher than a predetermined intermediate value; determining the on and off of the dot in the arrangement having the first characteristic in the first pixel group, and determining the on and off of the dot in the arrangement having the second characteristic in the second pixel group; and forming an output image including a plurality of pixels, with the dot, using a result of the halftone processing.

(3) The present disclosure may be implemented as an image processing device or an image processing method that processes an original image expressed with multiple tones into an output image expressed by a distribution of dots. In the image processing device and the image processing method, the output image includes a first pixel group including a plurality of pixels whose positions are determined in the output image, and a second pixel group including a plurality of pixels arranged at positions different from the pixels of the first pixel group, and in halftone processing of determining an on and off of dot formation in accordance with an input tone value of the original image, an arrangement of pixels where dots are formed in the first pixel group is made to have a distribution having a first characteristic relating to dispersibility, an arrangement of pixels where dots are formed in the second pixel group is made to have a distribution having a second characteristic relating to dispersibility and the distribution according to the second characteristic is not correlated with the distribution according to the first characteristic when the input tone value of the original image is equal to or higher than a predetermined intermediate value, the on and off of the dot in the arrangement having the first characteristic in the first pixel group is determined, and the on and off of the dot in the arrangement having the second characteristic in the second pixel group is determined.

Also, the present disclosure may be implemented as a program that causes a computer to realize the image forming method or the image processing method, and a computer-readable recording medium in which the program is recorded.

### BRIEF DESCRIPTION OF THE DRAWINGS

FIG. 1A shows a schematic configuration of a printing system according to an embodiment, mainly in terms of the contents of image processing.

FIG. 1B is a block diagram showing the configuration of an inkjet printer used in the printing system.

FIG. 2 is a cross-sectional view of essential parts showing a head unit of the inkjet printer and the state of transport of a medium.

FIG. 3 illustrates a nozzle arrangement for one color at a bottom surface of a print head.

FIG. 4 conceptually illustrates a part of a dither mask.

FIG. 5 illustrates how to determine to turn on and off dot formation using a dither mask.

FIG. 6 conceptually illustrates spatial frequency characteristics of a threshold set for each pixel in a dither mask having a blue noise characteristic.

FIGS. 7A-7C conceptually illustrate a visual spatial frequency characteristic VTF (Visual Transfer Function), which is a sensitivity characteristic in relation to the human visual spatial frequency.

FIG. 8 illustrates a state where a first pixel group and a second pixel group forming an output image are arranged alternately on every other raster.

FIG. 9 is a flowchart showing dither mask generation processing in the first embodiment.

FIG. 10 illustrates positions where thresholds are arranged in each of partial dither masks for the first pixel group and the second pixel group when dots are arranged alternately on every other raster.

FIG. 11 is a flowchart showing dither mask evaluation processing.

FIG. 12 illustrates a state where a dot is formed at four pixels corresponding to elements where thresholds that are the first to fourth most likely to result in the formation of a dot are stored, in the partial dither mask.

FIG. 13 illustrates a dot density mask formed by digitizing a dot pattern in which a dot is formed at five pixels in the partial dither mask, as dot density.

FIG. 14 illustrates a state where dots are formed separately in the first pixel group and in the second pixel group.

FIG. 15 illustrates a state where the first pixel group and the second pixel group made to coexist to form an output image.

FIG. 16 illustrates a state where dots formed by a first nozzle unit and a second nozzle unit are combined to form an output image.

FIG. 17 illustrates the relationship between a shift in the dot forming position and granularity.

FIG. 18 illustrates the relationship between a shift in the dot forming position and density change.

FIG. 19 illustrates an example in which the first pixel group and the second pixel group are arranged alternately in every other column in a mixture area, as a second embodiment.

FIG. 20 illustrates a configuration in which the mixture area has a checkered pattern, as a variation of the second embodiment.

FIG. 21 illustrates another configuration in which the mixture area has a checkered pattern, as a variation of the second embodiment.

FIG. 22 illustrates a configuration in which the mixture area has a random pattern, as another variation of the second embodiment.

FIG. 23 illustrates another configuration in which the mixture area has a random pattern, as another variation of the second embodiment.

FIG. 24 illustrates an embodiment in which nozzle rows are arranged in a staggered manner, as a third embodiment.

FIG. 25 illustrates a configuration in which nozzle rows are obliquely arranged in relation to a printing direction, as a variation of the third embodiment.

FIG. 26 illustrates a configuration in which nozzle rows are arranged obliquely and in a staggered manner.

### DESCRIPTION OF EMBODIMENTS

### A. First Embodiment

### (A1) Overall Configuration of Printing Device

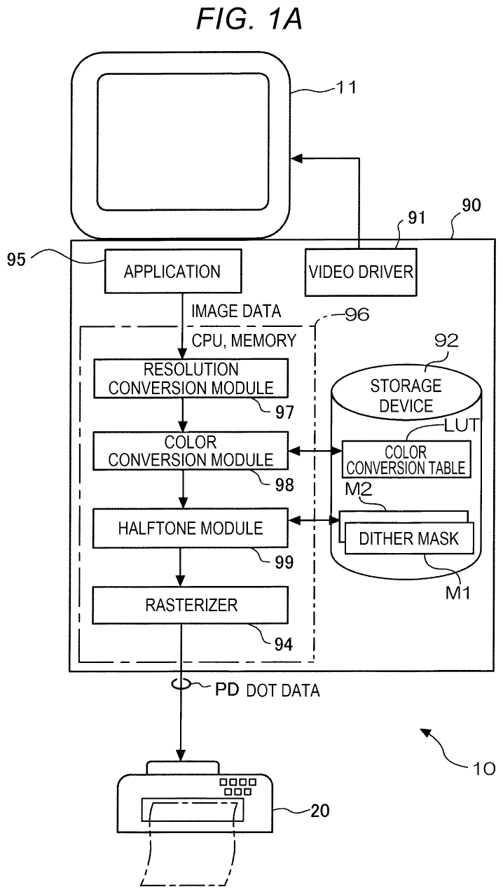

FIG. 1A is a block diagram illustrating the configuration of a printing system 10 according to a first embodiment. The printing system 10 includes a host computer (hereinafter simply referred to as a computer) 90 that processes an original image and outputs data of an output image, and an inkjet printer 20 that can form a full-color image.

The computer 90 includes a known CPU and memory, and an application program 95 operates under a predetermined operating system. A video driver 91 and a printer driver 96 are incorporated in the operating system, and the application program 95 outputs print data PD to be transferred to the inkjet printer 20, via these drivers. The application program 95 performs desired processing on a processing target image and displays an image on a display 11 via the video driver 91.

As the application program 95 issues a print command, the printer driver 96 in the computer 90 receives image data from the application program 95 and converts the image data into the print data PD to be supplied to the inkjet printer 20. In the example shown in FIG. 1A, a resolution conversion module 97, a color conversion module 98, a halftone module 99, and a rasterizer 94 are provided inside the printer driver 96. In the computer 90, a storage device 92 such as a hard disk is provided in addition to the CPU and the memory performing the series of processing, and a program for performing various kinds of processing, a color conversion table LUT referred to by the color conversion module 98 in color conversion processing, dither masks DM1 and DM2 referred to by the halftone module 99 in halftone processing, and the like are stored in the storage device 92.

The resolution conversion module 97 has a function of converting the resolution (that is, the number of pixels per unit length) of color image data used by the application program 95, into the resolution that can be used by the printer driver 96. The image data, on which the resolution conversion is thus performed, still is image information made up of the three colors of RGB. The color conversion module 98 refers to the color conversion table LUT and converts the RGB image data for each pixel into multi-tone data of a plurality of ink colors that can be used by the inkjet printer 20.

The color-converted multi-tone data has, for example, tone values of 256 tones. The halftone module 99 executes halftone processing of forming ink dots in a distributed manner to express the tone values by the inkjet printer 20. The image data, on which the halftone processing is performed, is rearranged in the order of data to be transferred to the inkjet printer 20, by the rasterizer 94, and is output as final print data PD. The print data PD includes raster data indicating the recording state of dots during each main scanning and data indicating the amount of sub-scanning feed. The contents of the halftone processing will be described later.

### (A2) Configuration of Inkjet Printer

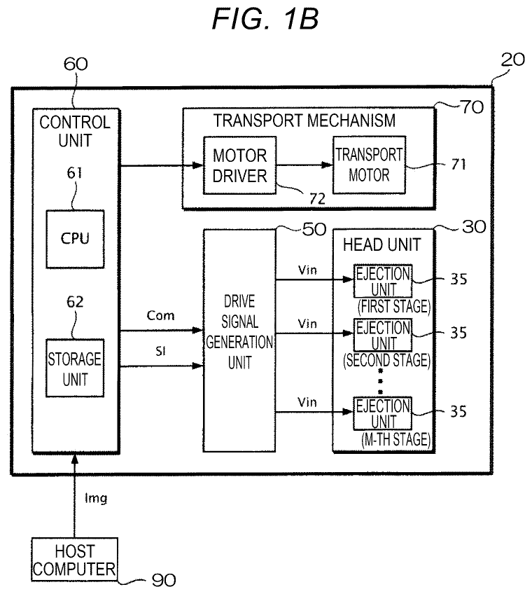

The configuration of the inkjet printer 20 according to the present embodiment will now be described with reference to FIG. 1B and FIG. 2. As shown in FIG. 1B, the inkjet printer 20 includes a head unit 30 that ejects liquid droplets, a drive signal generation unit 50 that drives the head unit 30, a transport mechanism 70 that transports a print medium, and a control unit 60 that executes various kinds of processing.

The head unit 30 has M ejection units 35. In the embodiment, M is a natural number equal to or greater than 4, but M may be 1, that is, the number of head units 30 may be one. The drive signal generation unit 50 generates and outputs a drive signal Vin for driving the head unit 30. The transport mechanism 70 changes the relative position of a medium P in relation to the head unit 30. The control unit 60 controls the operations of each unit in the inkjet printer 20 such as the head unit 30 and the drive signal generation unit 50.

The inkjet printer 20 includes, for example, a display unit, an operation unit, and the like, but these members are not illustrated. The display unit is configured with a liquid crystal display, an organic EL display, an LED lamp, and the like, and displays the state of the inkjet printer 20 and an instruction or an error message or the like to the user. The operation unit includes various switches and the like for inputting an instruction of the user, and an operation panel having such switches and the like. The display unit may be configured to represent the content of the display by voice, and similarly, the operation unit may be configured to input an instruction, using voice recognition or the like. The display unit and the operation unit can be easily implemented by a mobile terminal such as a mobile phone or a computer that is wired or wirelessly connected.

In the present embodiment, the inkjet printer 20 is a line printer, and ejects liquid droplets from the head unit 30 onto the medium P transported by the transport mechanism 70 and thus forms an image on the medium P. This state is schematically shown in FIG. 2. As indicated by arrows X, Y, and Z in the illustration, in the following description, the direction in which the medium P is transported is defined as X, the width direction of the medium P is defined as Y, and the direction orthogonal to the X direction and the Y direction is defined as Z. With respect to the X direction, the direction from upstream to downstream of the medium P is referred to as the +X direction, and with respect to the Y direction, the direction from the right side (the back side in the illustration) to the left side (the front side in the illustration) when the medium P is viewed in the +X direction is referred to as the +Y direction, and with respect to the Z direction, the direction from the medium P toward the head unit 30 in the Z direction is referred to as the +Z direction. The −X, −Y, and −Z directions are opposite to the +X, +Y, and +Z directions, respectively. These directions are also shown suitably in other drawings when necessary. Since the medium P moves in the +X direction in relation to the head unit 30, the ink dots formed on the medium P are sequentially arrayed from downstream to upstream on the medium P as the printing progresses.

The transport mechanism 70 for transporting the medium P from upstream to downstream includes a transport motor 71 serving as a transport drive source, and a motor driver 72 for driving the transport motor 71. As shown in FIG. 2, the transport mechanism 70 includes a platen 77 provided below (in FIG. 2, in the −Z direction of) the head unit 30, transport rollers 73 and 74 rotating by the operation of the transport motor 71, and guide rollers 75 and 76 driven by the rotation of the transport rollers 73 and 74. The medium P is transported in the +X direction (from upstream to downstream) in the illustration, along a transport path defined by the transport roller 73, the guide roller 75, the platen 77, the guide roller 76, and the transport roller 74.

The inkjet printer 20 includes a carriage 32, and accommodates the head unit 30 including the M ejection units 35 in the carriage 32. The carriage 32 houses the drive signal generation unit 50 (not shown in FIG. 2) and four ink cartridges 31 in addition to the head unit 30. The carriage 32 is disposed on the opposite side of the transport path of the medium P from the platen 77, that is, above (in the +Z direction of) the platen 77.

The four ink cartridges 31 are provided in one-to-one correspondence to the four colors of yellow, cyan, magenta, and black, and the ink cartridges 31 are filled with inks of the colors corresponding to the ink cartridges 31. Each of the M ejection units 35 receives the ink supplied from one of the four ink cartridges 31. Each of the ejection units 35 fills the inside thereof with the ink supplied from the ink cartridge 31 and ejects the ink filling the inside, as a liquid droplet toward the medium P. Thus, the inks of the four colors can be ejected from the M ejection units 35 as a whole, and full-color printing is implemented. The mechanism of ejecting liquid droplets and the like are known and therefore the description thereof is omitted.

The inkjet printer 20 according to the present embodiment has the four ink cartridges 31 corresponding to the inks of the four colors, but is not necessarily limited to four colors and may have three or fewer, or five or more ink cartridges 31 corresponding to inks of three or fewer, or five or more colors. Also, the inkjet printer may have an ink cartridge 31 filled with an ink of a different color from the four colors or only an ink cartridge 31 corresponding to a part of the four colors. That is, the inkjet printer according to the present disclosure may simply need to be able to eject an ink of one or more colors from the ejection unit 35. Also, instead of being installed in the carriage 32, each ink cartridge 31 may be provided at another location in the inkjet printer 20 and may supply ink to each of the ejection units 35 in the head unit 30 via a tube or the like. The inkjet printer 20 may perform printing in a single color, for example, black only. In this case, M may include a value of 1, that is, a single ejection unit 35 may be provided.

The timing of the transport of the medium P and the timing of the ejection of the liquid droplets from each of the ejection units 35 in the head unit 30, or the like, are controlled by the control unit 60. Under the control of the control unit 60, each of the ejection units 35 ejects ink onto the medium P at the timing when the medium P is transported to a desired position on the platen 77 by the transport mechanism 70, and thus forms an image on the medium P.

As illustrated in FIG. 1B, the control unit 60 receives an input of data (hereinafter referred to as dot data) indicating the on and off of a dot generated by the computer 90 such as a personal computer or a digital camera performing halftone processing on image data Img, and controls the drive signal generation unit 50, the transport mechanism 70, and the like to form an image corresponding to the image data Img on the medium P. Specifically, the control unit 60 drives the transport motor 71 in such a way as to feed the long medium P in the transport direction (+X direction) via the control of the motor driver 72, and controls whether to eject ink from each ejection unit 35 and the ink ejection timing via the control of the drive signal generation unit 50. Thus, the control unit 60 adjusts the arrangement of the ink dots formed by the ink ejected onto the medium P, and executes the print processing of forming the image based on the dot data on the medium P. Also, the control unit 60 may execute processing of transferring an error message or information of ejection abnormality or the like to the computer 90 when necessary.

The control unit 60 has a CPU 61 and a storage unit 62. The storage unit 62 includes a RAM (random-access memory) which temporarily stores data necessary for executing various kinds of processing such as print processing including dot data supplied from the computer 90 via an interface unit, not shown, or in which a control program for executing various kinds of processing such as a print processing is temporarily loaded, and a PROM that is a kind of nonvolatile semiconductor memory storing a control program for controlling each unit in the inkjet printer 20.

The CPU 61 stores the dot data supplied from the computer 90, in the storage unit 62. The halftone processing is binarization to define whether to form ink dots when there is only one size of ink dots that can be formed with liquid droplets ejected by each ejection unit 35, 3-value conversion to define whether to form no ink dots, small ink dots, or large ink dots when ink dots can be formed in the two sizes of small and large, and 4-value conversion to define whether to form no ink dots, small ink dots, medium ink dots, or large ink dots when ink dots can be formed in the three sizes of small, medium, and large. When light-colored ink such as ink of light magenta or light cyan is contained in the ink cartridge 31, halftone processing with a larger number of tones can be performed. In the present embodiment, as described later, each ejection unit 35 can form one type of dot, and the control unit 60 performs binarization. Such halftone processing may be performed on the side of the inkjet printer 20, and the inkjet printer 20 may receive the image data Img that is not subjected to the halftone processing from the computer 90, then perform the halftone processing, and print the image.

The CPU 61 of the control unit 60 generates signals such as a print signal SI and a drive waveform signal Com for controlling the operation of the drive signal generation unit 50 to drive each ejection unit 35, based on the various data such as the image data Img stored in the storage unit 62, and also generates various signals such as a control signal for controlling the operation of the motor driver 72, based on the various data stored in the storage unit 62, and outputs the generated various signals. In this way, the control unit 60 (CPU 61) generates the various signals such as the print signal SI and the drive waveform signal Com, supplies the signals to each unit in the inkjet printer 20, and thus comprehensively controls the operation of each unit in the inkjet printer 20. Thus, various kinds of processing such as print processing are implemented.

The drive signal generation unit 50 generates a drive signal Vin for driving each of the M ejection units 35 provided in the head unit 30, based on the print signal SI and the drive waveform signal Com supplied from the control unit 60. The detailed description of the generation of these signals is omitted.

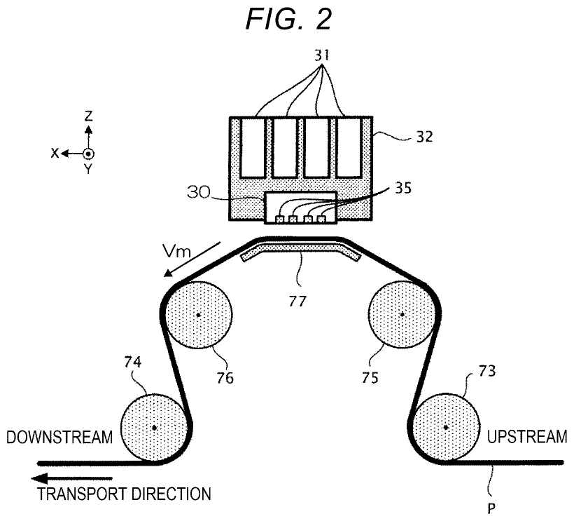

FIG. 3 illustrates the arrangement of nozzles that eject black liquid droplets at the bottom surface of the head unit 30 of the inkjet printer 20. Since the inkjet printer 20 is a line printer, the width thereof in the Y direction of the ejection unit 35 of the head unit 30 is larger than the width of the medium P, but in order to form the ejection unit 35 for ejecting liquid droplets across the width, a plurality of short nozzle heads in which a predetermined number of nozzles N are arranged are arranged in such a way as to partially overlap each other in the X direction. In the illustration, only a first nozzle unit 35a and a second nozzle unit 35b, each including 24 nozzles N in the Y direction, are shown in order to facilitate understanding. The first nozzle unit 35a, the second nozzle unit 35b, and the like are positioned and fixed to the head unit 30 with a screw 36. Although the adjacent nozzle units are arranged in a staggered manner, the eight nozzles N at their respective end parts are illustrated as overlapping each other when viewed in the X direction. In the actual ejection unit 35, the number of nozzles in each nozzle unit is several hundred, and the number of overlapping nozzles in adjacent nozzle units is approximately 120.

The pitch pt between the nozzles N provided in each nozzle row can be appropriately set according to the print resolution (dpi or dots per inch). The print resolution of the inkjet printer 20 according to the present embodiment is “720×720” dpi. The resolution in the Y direction e inkjet printer 20 depends on the configuration of the head unit 30, specifically, the interval of the arrangement of the nozzles N, and the resolution in the X direction depends on the ejection interval of liquid droplets from the ejection unit 35 and the transport speed of the medium P by the transport mechanism 70. These elements can be freely set, based on the design of the inkjet printer 20.

In this example, in an area L1, dots are formed only by the first nozzle unit 35a, and in an area L2, dots are formed only by the second nozzle unit 35b. In a mixture area LA where the two nozzle units 35a and 35b overlap each other, dots are formed by the first nozzle unit 35a and the second nozzle unit 35b. In the areas L1 and L2, the interval between dots formed on the medium P is equal to the pitch pt between adjacent nozzles N, and the dot interval does not change. In contrast, in the mixture area LA, dots formed by the first nozzle unit 35a and dots formed by the second nozzle unit 35b coexist and therefore there is a shift Δd in the dot forming position in the mixture area LA, corresponding to the shift in the arrangement of the nozzles N between the first nozzle unit 35a and the second nozzle unit 35b. In the illustration, the shift Δd is illustrated as being smaller than the pitch pt between adjacent nozzles, but when the nozzle N is formed, for example, with 720 dpi, the pitch pt between the nozzles N is 25.4 mm/720≈35 μm. Therefore, if the first and second nozzle units 35a and 35b are fixed with the screws 36 or the like, the shift may be larger than the nozzle pitch pt, for example, approximately several times the nozzle pitch pt, depending on the mechanical attachment accuracy. The configuration of the ejection unit 35 is the same for the ejection unit 35 of inks of other colors.

In the present embodiment, the plurality of nozzles N forming each nozzle row are arranged in such a way as to be arrayed in one row in the Y-axis direction, but the positions of the even-numbered nozzles N and the odd-numbered nozzles N from the left in the illustration, of the plurality of nozzles N forming each nozzle row, may be arranged in lines shifted from each other in the X direction, that is, in a so-called zigzag pattern.

In the inkjet printer 20, when liquid droplets are ejected from the ejection unit 35, the medium P is transported by the transport mechanism 70 at a predetermined transport speed Vm in the +X direction in FIG. 2. The transport speed Vm (printing speed) of the inkjet printer 20 according to the present embodiment is “220 m/min” or higher. As liquid droplets are ejected from the nozzles N of the head unit 30 to form ink dots on the medium P while the medium P is transported, an image is recorded on the medium P. That is, the image is recorded as a set of ink dots formed by liquid droplets ejected from the nozzles N arranged at the print resolution in the Y direction. When focusing on one ejection unit 35, ink dots formed by liquid droplets ejected from the nozzles forming the ejection unit 35 are arrayed in the width direction (Y direction) of the medium P. Therefore, in this line printer, the array of ink dots along the width direction of the medium P is called a “raster”.

### (A3) Halftone Processing

The inkjet printer 20 having the above-described hardware configuration receives an input of halftone-processed dot data from the computer 90, and drives the head unit 30 according to the dot data while transporting the medium P by the transport motor 71. Thus, liquid droplets of the respective colors are ejected onto the transported medium P, and a multicolor multi-tone image is thus formed on the medium P. The halftone processing of generating the dot data will be described below. The halftone processing in the present embodiment is performed by a systematic dithering method using a dither mask that provides a dot arrangement with excellent dispersibility.

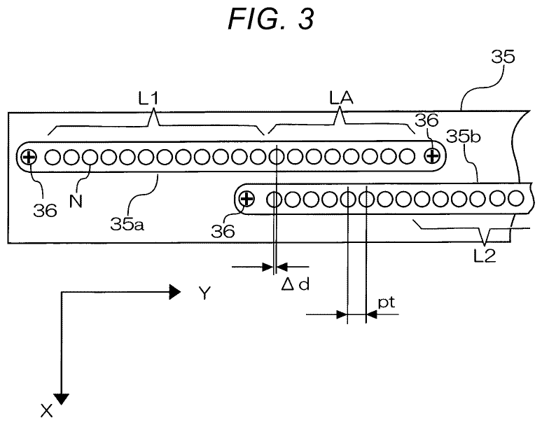

FIG. 4 conceptually illustrates a part of the dither mask. In the illustrated mask, thresholds selected evenly from a range of tone values 1 to 255 are stored at 128 elements in the arrangement direction of the plurality of nozzles N (Y direction, hereinafter also referred to as a main scanning direction) and 64 elements in a direction intersecting the arrangement direction of the nozzles (X direction, hereinafter also referred to as a sub scanning direction), that is, a total of 8192 elements. The dither mask is created in advance and stored in the storage device 92. The size of the dither mask is not limited to the size illustrated in FIG. 4, and dither masks of various sizes including a mask where the numbers of elements in the vertical direction and horizontal direction are the same can be employed.

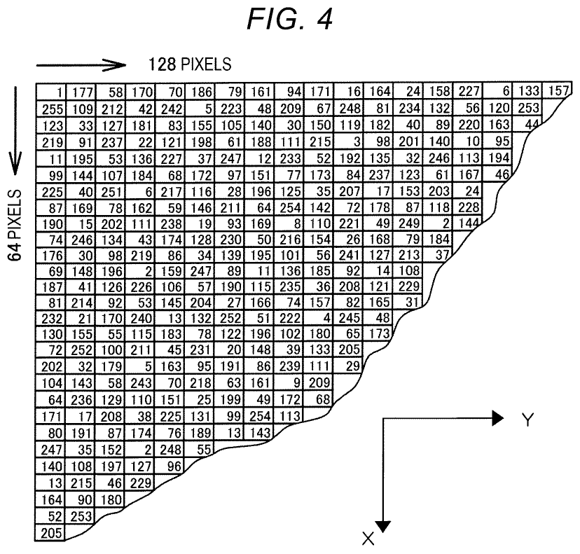

FIG. 5 illustrates how to determine whether to perform dot formation using the dither mask. For the sake of convenience of illustration, only some of the elements are shown. In determining whether to perform dot formation, as shown in FIG. 5, the tone value of the image data is compared with the threshold stored at the corresponding position in the dither mask. When the tone value of the image data is higher than the threshold stored in the dither mask, a dot is formed, and when the tone value of the image data is lower, a dot is not formed. A hatched pixel in the illustration represents a pixel where a dot is formed. In this way, with the use of the dither mask, whether to form a dot at each pixel can be determined by the simple processing of comparing the tone value of the image data with the threshold set in the dither mask, and therefore number-of-tones conversion processing can be performed swiftly. Also, as is clear from the fact that when the tone value of the image data is determined, whether a dot is formed at each pixel depends on the threshold set in the dither mask, in the systematic dithering method, the status of formation of dots and the dispersibility of formed dots can be controlled, based on the storage position of the threshold set in the dither mask. Therefore, the arrangement of dots formed by the halftone processing can be optimized by the dither mask optimization processing. The dither mask optimization processing will be described in detail later.

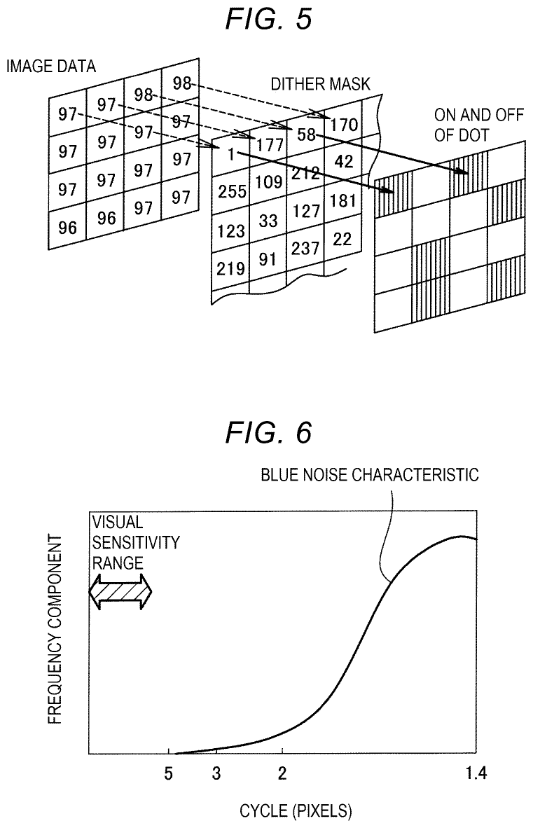

FIG. 6 conceptually illustrates spatial frequency characteristics of a threshold set at each pixel of a blue-noise dither mask having a blue noise characteristic, as a simple example of the adjustment of the dither mask. The spatial frequency characteristic of the blue-noise mask has a characteristic of having the largest frequency component in a high-frequency range where the length of one cycle is two pixels or less. Such spatial frequency characteristics are set in consideration of human visual characteristics. That is, the blue-noise dither mask is a dither mask in which the storage position of the threshold is adjusted in such a way that the largest frequency component is generated in the high-frequency region in consideration of a human visual characteristic of having low sensitivity in the high-frequency region.

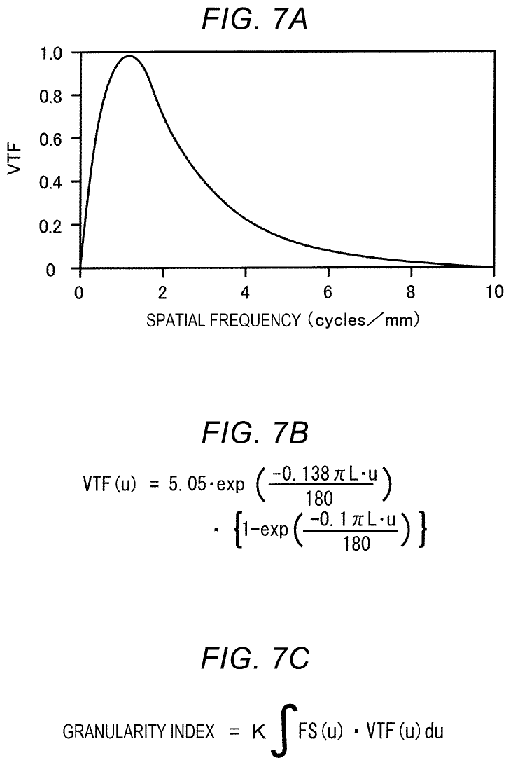

FIG. 7A conceptually illustrates a visual spatial frequency characteristic VTF (Visual Transfer Function), which is a sensitivity characteristic in relation to the human visual spatial frequency. With the use of the visual spatial frequency characteristic VTF, the granularity of halftone-processed dots that appeals to the human vision can be quantified by modeling the human visual sensitivity as a transfer function referred to as the visual spatial frequency characteristic VTF. The quantified value is called a granularity index. FIG. 7B shows a representative experimental formula representing the visual spatial frequency characteristic VTF. The variable L in FIG. 7B represents the observation distance, and the variable u represents the spatial frequency. FIG. 7C shows a formula that defines the granularity index. The coefficient K in FIG. 7C is a coefficient for matching the obtained value with the human sense.

For the calculation of the granularity index of the printed image, which is two-dimensional, normally the integration in FIG. 7C is executed with respect to the frequency components in all directions on the medium. However, in the present embodiment, the granularity index for each direction is calculated by limiting the range in which the integration in FIG. 7C is performed, to a part of the directions. As will be described later, the granularity index for each direction can be used as an index corresponding to a characteristic and a second characteristic relating to the dispersibility.

The quantification of the granularity that appeals to human vision enables fine optimization of the dither mask in relation to the human visual system. Specifically, a granularity evaluation value that can be obtained by performing Fourier transform on a dot pattern expected when each input tone value is input to the dither mask, thus finding a power spectrum FS, performing filter processing of multiplying the power spectrum FS by the visual spatial frequency characteristic VTF, and then performing the integration with all the input tone values (FIG. 7C), can be used as an evaluation function of the dither mask. In this example, the optimization can be achieved by adjusting the storage position of the threshold in such a way that the evaluation function of the dither mask decreases.

When the print resolution is sufficiently high and a peak appears in a range without visual sensitivity, the dither mask may be adjusted in such a way as to have a green noise characteristic instead of the blue noise characteristic. In this case, the green noise characteristic can be provided for the dither mask by applying a predetermined bias to the VTF function or a low-pass filter described later. The predetermined bias can be configured by simulatively lowering the sensitivity of the VTF function, for example, in the peak frequency band of the green noise characteristic.

### (A4) Generation of Dither Mask on Assumption of Dot Formation by Different Nozzle Units

As described above, when forming one raster, in the inkjet printer 20 according to the present embodiment has the area where only a single nozzle unit operates for the dot formation and the mixture area where two nozzle units operate for the dot formation. In the example shown in FIG. 3, in the area L1, dots are formed only by the first nozzle unit 35a, and in the mixture area LA, dots are formed by the first nozzle unit 35a and the second nozzle unit 35b, and in the area L2, dots are formed only by the second nozzle unit 35b.

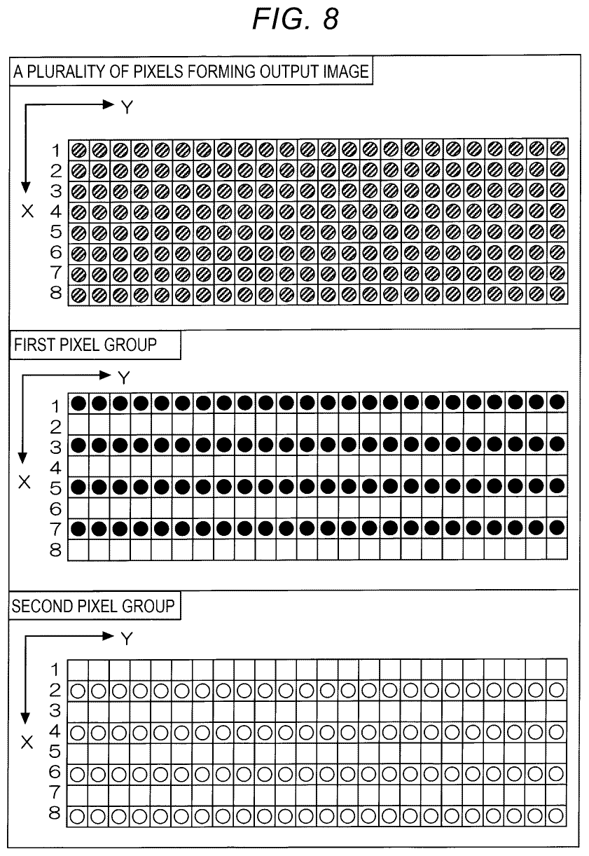

Therefore, the pixels of the output image are grouped as follows. Of the plurality of pixels forming the output image, 24 pixels in the horizontal direction (Y direction) by eight pixels in the vertical direction (X direction) are shown in the top section in FIG. 8. The arrays of pixels arranged in the horizontal direction are also referred to as rasters. In the illustration, raster numbers are given at the left end.

First pixel group: a group of pixels belonging to odd-numbered rasters in the X direction in order from the first raster, as indicated by “•” in the middle section in FIG. 8.

Second pixel group: a group of pixels belonging to even-numbered rasters in the X direction in order from the second raster, as indicated by “∘” in the bottom section in FIG. 8.

As described above, the plurality of pixels forming the output image are divided into two pixel groups corresponding to every other raster, where a raster is a base unit, and then the formation of dots when the input tone value of the original image is a predetermined intermediate value is performed as follows. That the input tone value of the original image is the predetermined intermediate value corresponds to, for example, a state where the tone value is in a range of 0 to 255 and when the tone value is a value 31, which is approximately one-eighth of the maximum value, and when the dot gain is ignored, a dot is formed at one-eighth of all the pixels, that is, 12 pixels on average of the 24×4 pixels forming the first pixel group illustrated in FIG. 8.

The arrangement of the pixels where a dot is formed in the first pixel group has a distribution having the first characteristic relating to dispersibility. That is, the formation of dots is determined using the dither mask in which the threshold is set in such a way that the distribution of 12 pixels formed at this time represents the dispersibility such as the blue noise characteristic described as an example. Similarly, the arrangement of the pixels where a dot is formed in the second pixel group has the second characteristic relating to dispersibility. The first characteristic of the distribution of the pixels where a dot is formed in the first pixel group and the second characteristic of the distribution of the pixels where a dot is formed in the second pixel group are not correlated with each other in terms of dispersibility, at least when the input tone value of the original image is an intermediate value equal to or higher than a predetermined value. Being not correlated in terms of the distribution of pixels means that the arrangement of dots in one pixel group is not referred to when determining the arrangement of dots in the other pixel group. Even if both of the two pixel groups have the blue noise characteristic, it can be said that the pixel groups are not correlated when the determination of the dot arrangement in one of the pixel groups is not influenced by the dot arrangement in the other pixel group. Thus, in the first pixel group, the on and off of the dots is determined, based on the arrangement having the first characteristic, and in the second pixel group, the on and off of the dots is determined, based on the arrangement having the second characteristic, which is not correlated with the first characteristic.

### (A5) Generation of Dither Mask

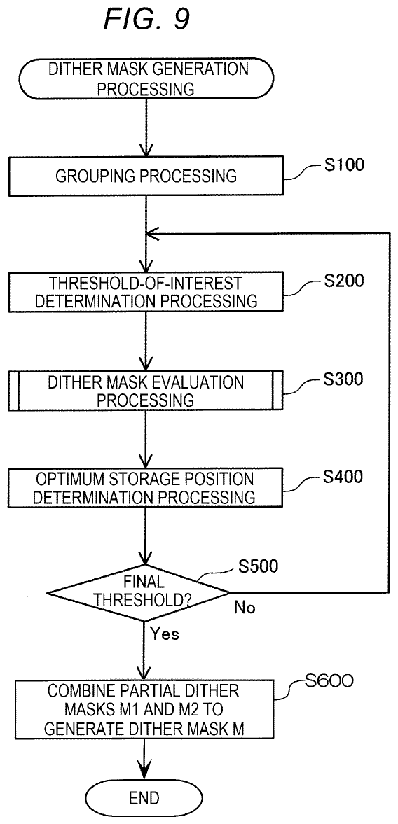

A method of generating the dither mask having the above characteristics will be described. FIG. 9 is a flowchart illustrating the processing routine of the dither mask generation method according to the first embodiment. The dither mask generation method is configured to be able to achieve optimization in consideration the of dispersibility of dots formed in each of the first pixel group and the second pixel group formed by dividing the pixels of the output image in an alternating pattern on every other raster.

As the dither mask generation processing is started, grouping processing is first performed (step S100). The grouping processing refers to processing in which a plurality of pixels forming an output image are virtually divided into a first pixel group and a second pixel group and in which the elements of the dither mask are divided into a first group and a second group accordingly. In the present embodiment, as described above, the pixels of the output image are virtually divided in the alternating pattern on every other raster, and therefore the elements of the dither mask are similarly divided in the alternating pattern on every other raster.

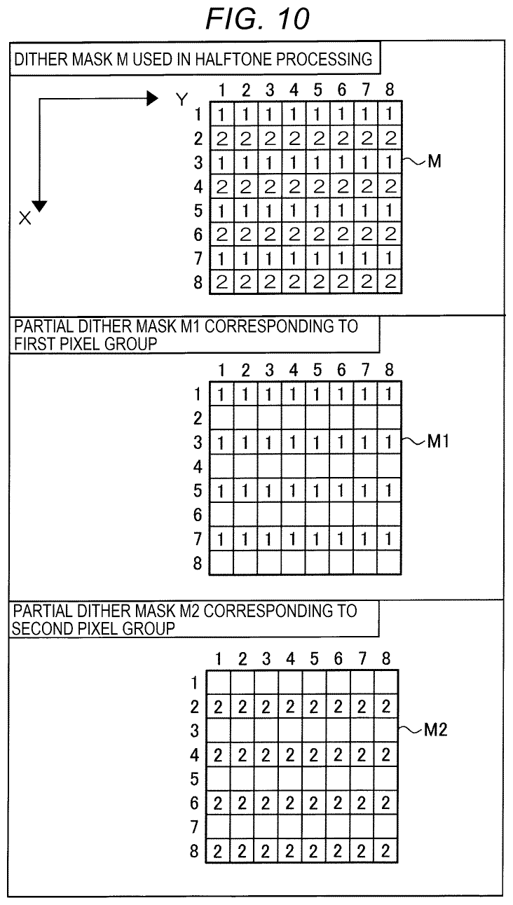

FIG. 10 shows a dither mask M used for the halftone processing based on the dithering method, and partial dither masks M1 and M2 when the dither mask M is divided in the alternating pattern on every other raster. In this example, a small dither mask of eight rows by eight columns is generated in order to facilitate the understanding of the description. The row numbers in the partial dither masks in the illustration are equivalent to the raster numbers in the output image. The numbers written at the elements of the partial dither masks M1 and M2 represent pixel groups to which the elements belong respectively. In this example, the elements in the odd-numbered rows belong to the first group corresponding to the first pixel group, and the elements in the even-numbered rows belong to the second group corresponding to the second pixel group.

The partial dither mask M1 includes a plurality of elements corresponding to the pixels belonging to the first pixel group among the elements of the dither mask, and blank elements, which are a plurality of elements that are blank. Meanwhile, the partial dither mask M2 includes a plurality of elements corresponding to the pixels belonging to the second pixel group among the elements of the dither mask, and blank elements, which are a plurality of elements that are blank. Such grouping processing is set on the assumption that printing is performed in the mixture area LA with the first nozzle unit 35a and the second nozzle unit 35b, which are different from each other, alternately on every other raster. The partial dither mask M1 and the partial dither mask M2, after being generated, are combined together to form the single dither mask M.

On completion of the grouping processing (step S100), threshold-of-interest determination processing (step S200) is performed next. In the threshold-of-interest determination processing, a threshold to be stored at each storage element of each of the partial dither masks M1 and M2 is determined. In the present embodiment, a threshold is selected in order from a threshold of a relatively small value, that is, a threshold of a value that is likely to result in the formation of a dot in the halftone processing based on the dithering method, and the threshold is thus determined. The reason for this will be described later.

After the threshold is determined by the threshold-of-interest determination processing, dither mask evaluation processing (step S300) is performed. The dither mask evaluation processing is processing of digitizing the optimality of the dither mask, based on a preset evaluation function. In the present embodiment, as an evaluation function, a two-dimensional granularity index defined by a calculation formula expressing the one-dimensional granularity index calculated by the calculation formula in FIG. 7C, a two-dimensional area in consideration of the direction of the print image, is used. The partial dither masks M1 and M2 are evaluated, using the two-dimensional granularity index. Details of the two-dimensional granularity index will be described later.

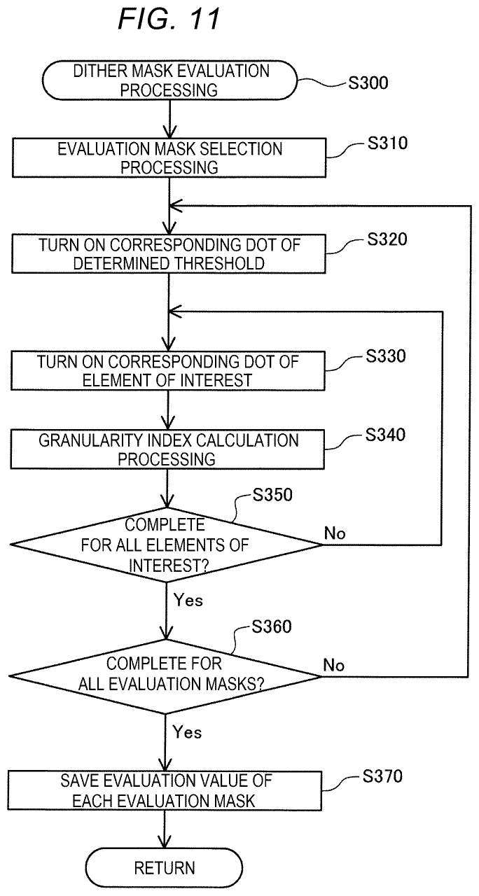

The dither mask evaluation processing will be described in detail with reference to the flowchart of FIG. 11. As the processing is started, first, evaluation mask selection processing is performed (step S310). In the present embodiment, the evaluation mask selection processing is processing of selecting one of the two partial dither masks M1 and M2 in order. First, on the assumption that the partial dither mask M1 is selected as an evaluation mask, the processing after that will be described.

Subsequently, the corresponding dot of the determined threshold is turned on (step S320). The determined threshold means a threshold for which a storage element is determined. In the present embodiment, since a threshold is selected in order from a threshold of a value that is likely to result in the formation of a dot, as described above, when a dot is formed for the threshold of interest, a dot is always formed at the pixel corresponding to the element where the determined threshold is stored. In contrast, in the case of the smallest input tone value such that a dot is formed for the threshold of interest, no dot is formed at the pixel corresponding to an element other than the element where the determined threshold is stored.

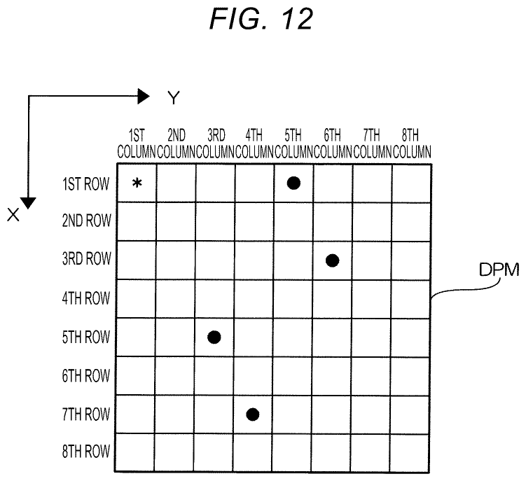

FIG. 12 illustrates a dot pattern DPM in which a dot (• symbol) is formed at each of four pixels corresponding to elements where thresholds that are the first to fourth most likely to result in the formation of a dot are stored, in the partial dither mask M1. This dot pattern is used to determine which pixel to form the fifth dot at. That is, the dot pattern is used to determine the storage element for the threshold of interest that is the fifth most likely to result in the formation of a dot. A * symbol represents a pixel corresponding to the element of interest.

Subsequently, the corresponding dot at the element of interest is turned on (step S330). In this example, the element of interest is one of candidates for the storage element for the threshold of interest that is the fifth most likely to result in the generation of a dot. The element of interest is selected from the elements of the evaluation mask (in this example, the partial dither mask M1) and therefore is selected from the elements in the odd-numbered rows.

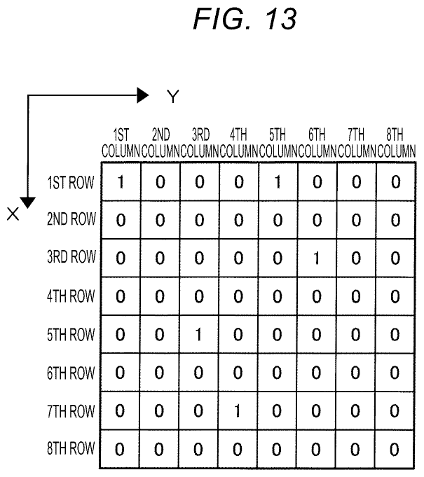

Subsequently, granularity index calculation processing is performed (step S340). The granularity index calculation processing is processing of calculating the granularity index when it is assumed that a dot is formed at the pixel corresponding to the element of interest, based on the foregoing calculation formula, with respect to the dot pattern DPM. This processing is performed, based on a dot density mask formed by digitizing a dot pattern shown in FIG. 13. The illustrated dot density mask is configured by setting the value of a pixel where a dot is formed, to be “1”, and setting the value of a pixel where a dot is not formed, to be “0”.

The processing of step S330 and step S340 is performed, taking all the elements in the odd-numbered rows except the elements where the thresholds that are the first to fourth most likely to result in the formation of a dot are already stored, sequentially as the element of interest. When the processing of changing the pixel of interest and causing a dot to be formed at that pixel (step S330) and the calculation of the granularity index in that state, that is, in the state where five dots are on in this example (step S340), are complete for all the pixels that can be of interest (“Yes” in step S350), whether the processing is complete for all the evaluation masks, that is, the partial dither mask M1 and the partial dither mask M2, is determined (step S360). On completion of the processing for the partial dither mask M1, the evaluation mask is changed to the partial dither mask M2, then the processing returns to step S320, and the processing of steps S320 to S350 is repeated for the partial dither mask M2. The processing for the partial dither mask M2 is similar to the processing for the partial dither mask M1, except that the processing is performed on the elements in the even-numbered rows.

When the calculation of the granularity index at all the pixel-of-interest positions that can be applied to all the evaluation masks, in this example, the partial dither mask M1 and the partial dither mask M2, is finished, the evaluation value for each mask is saved (step S370), and the dither mask evaluation processing ends.

Subsequently, the processing of step S400 in FIG. 9 is performed. This processing is optimum storage position determination processing. The optimum storage position determination processing is processing of determining an element where a threshold that is next most likely to result in the formation of a dot is stored (a storage position in the partial dither mask). The storage element is determined separately for the partial dither mask M1 and for the partial dither mask M2, based on the saved evaluation values. In this example, a pixel of interest such that the granularity index is the smallest when a dot are formed at the pixel of interest is set as the optimum storage position for each threshold, but a pixel position that does not have the smallest granularity index for a certain threshold may subsequently have the smallest granularity index for the threshold that is the next most likely to result in the formation of a dot. In preparation for such a case, all the evaluation values for each threshold in each evaluation mask may be saved and so-called annealing processing may be performed to find an optimum storage position of the threshold.

Whether such processing is already performed for all the thresholds from the threshold that is most likely to result in the formation of a dot to the threshold that is least likely to result in the formation of a dot is determined (step S500), and when it is determined that all the thresholds are arranged (“Yes” in step S500), the partial dither mask M1 and the partial dither mask M2 that are acquired are combined together to generate the dither mask M used in the halftone processing (step S600), and the dither mask generation processing ends.

### (A6) Dot Forming Method

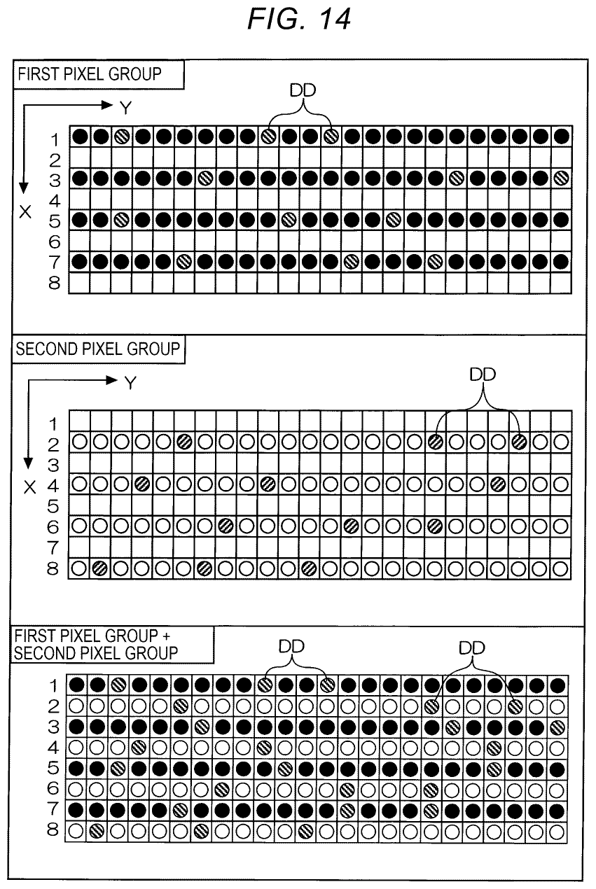

The on and off of dots when the halftone processing is performed using the dither mask M generated by combining the partial dither mask M1 and the partial dither mask M2 generated by the above method will now be described. FIG. 14 shows a case where the dither mask M is applied to each of the first pixel group and the second pixel group. In the illustration, a dot DD with oblique hatching indicates that it is determined that a dot is formed there in the halftone processing. The positions of the dots to be formed are examples. In the halftone processing, the partial dither mask M1 or the partial dither mask M2 may be used instead of the dither mask M. In the first pixel group, dots are formed on the odd-numbered rasters, and in the second pixel group, dots are formed on the even-numbered rasters, and therefore there is no difference in the result no matter which dither mask is used.

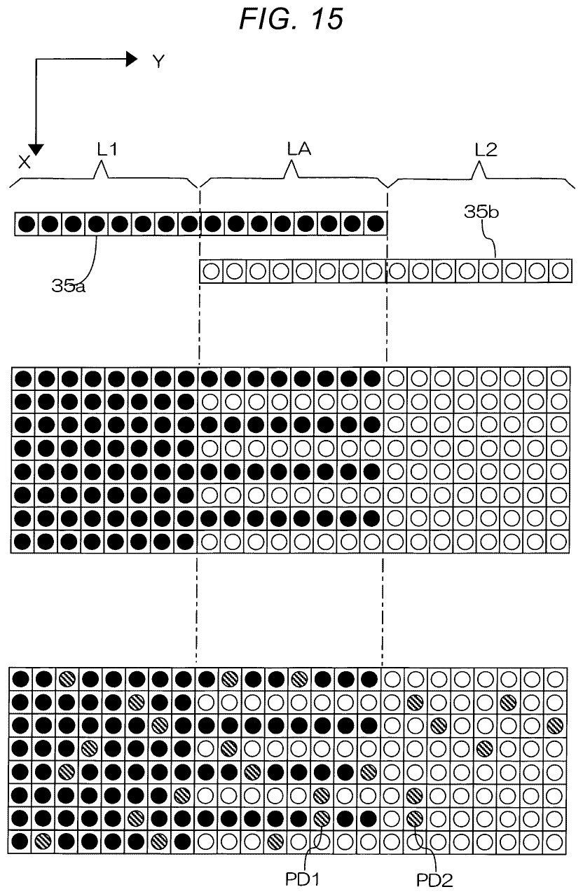

In the bottom section in FIG. 14, the two pixel groups are shown together. When the output image is printed, for example, by a serial printer, in which dots are formed in the first pixel group during a forward movement of the print head and in which dots are formed in the second pixel group during a backward movement of the head, dots are formed on the medium P from liquid droplets ejected from the same head for both the first pixel group and the second pixel group, in the illustration in the bottom section in FIG. 14. Meanwhile, in a line printer having a plurality of ejection units 35 as in the inkjet printer 20 according to the present embodiment, the areas L1 and L2 where dots are formed by one of the first nozzle unit 35a and the second nozzle unit 35b, and the mixture area LA where dots are formed by both the first nozzle unit 35a and the second nozzle unit 35b, are present, as illustrated in FIG. 3. In this case, as illustrated in FIG. 15, even if dots are to be formed alternately on every other raster, only one of the first nozzle unit 35a and the second nozzle unit 35b can be used, except in the mixture area LA.

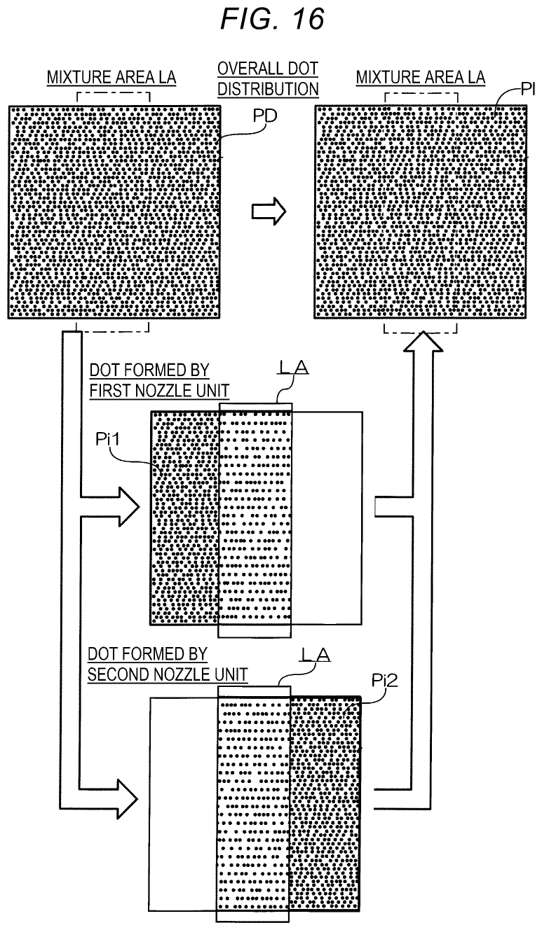

FIG. 16 schematically shows the state of forming an image including the mixture area LA. As shown in the illustration, the output image is expressed by the on and off using the dither mask M by the halftone module 99, and the arrangement of the dots thereof has the low granularity that is set when the dither mask M is generated. The inkjet printer 20, upon receiving the print data PD corresponding to the output image, forms dots by the first nozzle unit 35a and the second nozzle unit 35b, based on the dot data. At this time, as described with reference to FIG. 15, in the mixture area LA, dots are formed using the first nozzle unit 35a and the second nozzle unit 35b alternately on every other raster, and in the other areas, dots are formed only by the first nozzle unit 35a or only by the second nozzle unit 35b. Consequently, a print image PI formed on the medium P is an image made up of an image Pi1 made up of dots formed by the first nozzle unit 35a and an image Pi2 made up of dots formed by the second nozzle unit 35b, superimposed on each other.

At this time, since the first nozzle unit 35a and the second nozzle unit 35b are positioned and fixed by the screw 36 or the like, the positions where dots are formed by the two nozzle units in the mixture area LA are not the completely matching positions as shown in FIG. 15. In the present embodiment, as already described with reference to FIG. 3, if the pitch pt between the nozzles N is about 35 μm and the mechanical positioning accuracy with the screw 36 or the like is approximately 100 μm, the positional shift between the nozzles in the first nozzle unit 35a and the nozzles in the second nozzle unit 35b in the mixture area LA can be several times the nozzle pitch pt. To cope with such a shift, in the present embodiment, the arrangement of dots in the first pixel group, for which the first nozzle unit 35a forms dots, and the arrangement of dots in the second pixel group, for which the second nozzle unit 35b forms dots, have the blue noise characteristic, and therefore even if a shift by approximately several dots in the dot forming position in the mixture area LA is generated in the X direction or the Y direction, this shift does not lead to a significant drop in the granularity. Therefore, even if a relative shift occurs between the arrangement of the dots formed using the first nozzle unit 35a and the arrangement of the dots formed using the second nozzle unit 35b, there is no significant difference between the granularity in the mixture area LA and the granularity in the areas L1 and L2, and the deterioration in the image quality in the mixture area LA is sufficiently suppressed. This is due to the following reasons.

In the head unit 30 of the inkjet printer 20, the nozzles N are formed at the same pitch as the resolution (for example, 720 dpi), and therefore in the areas L1 and L2, the dot forming position does not shift in the Y direction or in the X direction, that is, between rasters. Meanwhile, in the mixture area LA, the dot forming position may shift by several dots in some cases, due to the influence of the positioning accuracy when the first nozzle unit 35a and the second nozzle unit 35b are attached. In such cases, when the dither mask M in which the arrangement of the thresholds used in the halftone processing based on the dithering method is provided with the blue noise characteristic is used, the granularity of the mixture area LA is deteriorated in accordance with the amount of shift in the dot forming position.

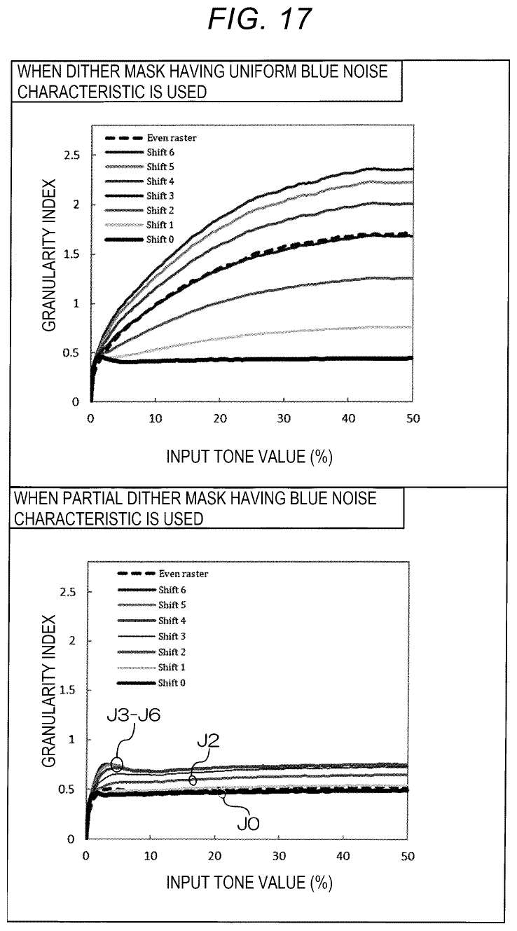

This state is shown in a section (A) in FIG. 17. In the illustration, the horizontal axis represents the input tone value of the image in a range of 0 to 50%, from the range of 0 to 100% thereof. The vertical axis represents the granularity index, and as it goes upward, the granularity deteriorates and the image quality drops. The illustration shows a graph representing the relationship between the input tone value and the granularity index, where the difference in the amount of shift between the dots formed by the first nozzle unit 35a and the dots formed by the second nozzle unit 35b in the mixture area LA is defined as a parameter (Shift 0-6). As illustrated, even when the dither mask having the blue noise characteristic is used, the granularity index in the mixture area LA deteriorates at any tone value as the amount of shift (shift) between the dots formed by the first nozzle unit 35a and the dots formed by the second nozzle unit 35b increases. As already described, in the other areas than the mixture area LA, there is no shift in the dot forming position, and the granularity thereof is equivalent to the case of Shift 0 in the illustration, and therefore when there is a shift in the dot forming position in the mixture area LA and the granularity deteriorates there, the way the image looks changes between the mixture area LA and the areas L1 and L2 and consequently the image quality drops significantly.

In contrast, in the present embodiment, each of the partial dither mask M1 and the partial dither mask M2 has the blue noise characteristic, and the characteristics thereof are not correlated. A section (B) in FIG. 17 shows the relationship between the input tone value and the granularity index when the characteristics of the partial dither mask M1 and the partial dither mask M2 are correlated as well. The correlation between the partial dither mask M1 and the partial dither mask M2 corresponds to a case where, in the dither mask evaluation processing of FIG. 11, the granularity of dots generated based on the threshold set from the side where a dot is likely to be formed, by the partial dither mask M1, and the threshold set from the side where a dot is likely to be formed, by the partial dither mask M2, is evaluated in total, and this is set to have the blue noise characteristic, or the like. Even when the dither mask is used, the granularity drops as the amount of shift increases. As illustrated, the granularity index is higher when the shift is by two dots (solid line J2) than when there is no shift (solid line J0), and the granularity index is even higher when the shift is by three to six dots (solid lines J3-6). However, the granularity index is suppressed to a fraction of the granularity index acquired when a dither mask having a single blue noise characteristic without using the partial dither masks M1 and M2 is used, and when the shift (Shift) is by three dots or more, approximately the same granularity index is acquired, as indicated by the solid lines J3-6. Moreover, even when the granularity index is the lowest, the image quality is maintained at a sufficient high level.

In this way, as compared to the dither mask further having a correlation between the partial dither mask M1 and the partial dither mask M2, the dither mask having no correlation between the partial dither mask M1 and the partial dither mask M2 has the granularity index corresponding to the case where the shift is by three to six dots, among the characteristics in the section (B) in FIG. 17, even when the amount of shift between the dots formed by the first nozzle unit 35a and the dots formed by the second nozzle unit 35b is 0. Therefore, as compared with the granularity index in the area L1 and the area L2, that is, when there is no shift in the dot forming position, the granularity index acquired when a shift by approximately several dots or less may occur in the dot forming position as in the mixture area LA does not significantly drop, and the difference in the granularity when viewed as an image is sufficiently suppressed. Therefore, the difference in the appearance between the areas L1 and L2 and the mixture area LA is suppressed and becomes substantially imperceptible.

The density difference between the areas L1 and L2 and the mixture area LA will now be described. When dots are formed by two different heads or scans, a density change may occur in addition to the drop in the granularity. FIG. 15 illustrates paired dots PD1 and paired dots PD2, which are dots adjacent to each other, of the dots formed in the first pixel group and the dots formed in the second pixel group. In this case, in the mixture area LA in the image formed in the alternating pattern on every other raster, when the dot positions formed by the second nozzle unit 35b shift by one each in the direction of the adjacent raster (downward direction in the illustration), the dot formed by the second nozzle unit 35b, of the paired dots PD1, completely overlaps the dot formed by the first nozzle unit 35a, and the area occupied by the dots on the medium P decreases and therefore the image density drops. Meanwhile, in the area L2, since the dot forming position does not shift in the direction of the adjacent raster, one of the paired dots PD2 does not overlap the other and the density drop does not occur, either. Thus, a difference in the way the image looks occurs between the areas L1 and L2 and the mixture area LA, and consequently the quality of the image may drop.

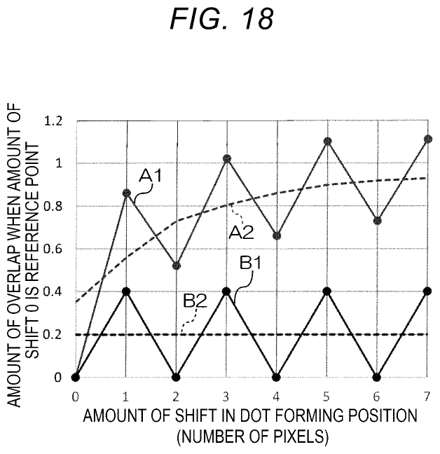

This phenomenon occurs every time a shift occurs by odd number of dots. This is shown in FIG. 18. A graph line A1 (solid line) and a graph line A2 (dashed line) represent a case where the generation rate of paired dots, in which dots are formed at two adjacent pixels of pixels belonging to different pixel groups, is not controlled, and a graph line B1 (solid line) and a graph line B2 (broken line) represent a case where the generation rate of paired dots is controlled. In the illustration, the vertical axis represents the rate of overlap at which a dot to be formed overlaps another dot (hereinafter also referred to as a coverage rate) in relation to a reference point where the amount of shift is 0. The graph lines A1 and B1 expressed by the solid lines indicate the result values of the simulation, and the graph lines A2 and B2 expressed by the dashed lines indicate the actual measurement values. When actually forming dots, due to differences in the ejection speed and the ejection direction of liquid droplets, the increase or decrease in the coverage rate of dots is not in a definite two-pixel cycle and generally has an average value, that is, as indicated by the dashed line A2 or the dashed line B2.

Therefore, it is desirable to use a dither mask in which the generation rate of paired dots is controlled to obtain the characteristics of the graph lines B1 and B2. Such characteristics are obtained by approximating the probability of dots being simultaneously formed at a pair of the first pixel and the second pixel to a value determined corresponding to the square of the input tone value, when the separation distance between the first pixel, which is a pixel selected from the first pixel group, and the second pixel, which is a pixel selected from the second pixel group, is shorter than a predetermined threshold. The method of approximating the probability of dots being simultaneously formed at the pair of the first pixel and the second pixel to the value determined corresponding to the square of the input tone value is disclosed in JP-A-2012-204939 or the like and is a known technique, and therefore the detailed description thereof is omitted. It is also found that, when both the partial dither mask M1 and the partial dither mask M2, already described, have the blue noise characteristic and the characteristics of the two dither masks are not correlated, the coverage rate of dots consequently becomes as indicated by the graph lines B1 and B2. This is because, when the distribution of the dots formed in the two pixel groups has the blue noise characteristic and high dispersibility and the dots formed in the two pixel groups are collectively viewed, paired dots are generated at a predetermined rate when there is no shift in the dot forming position, that is, even in the area L1 and the area L2, because the characteristic of the distribution of the dots formed in the first pixel group and the characteristic of the distribution of the dots formed in the second pixel group are not correlated with each other. Not correlating the characteristics of the two dither masks may be limited to the case where the input tone value of the original image is a predetermined intermediate value or higher. This is because, when the input tone value is low, the distance between the dots is sufficiently long and the overlap of dots due to the shift does not occur. In an area where the input tone value is sufficiently low, it is often preferable to increase the total granularity by correlating the characteristics of the partial dither masks M1 and M2.

Based on these results, in the printed image in the printing system 10 according to the present embodiment, even if there is a shift in the dot forming position due to the positioning accuracy of the first nozzle unit 35a and the second nozzle unit 35b in the head unit 30, the change in the granularity and density is sufficiently suppressed between the area L1 and the area L2, where dots are formed by one of the nozzle units, and the mixture area LA, where dots are formed by both of the nozzle units, and therefore high quality can be maintained.

### B. Second Embodiment

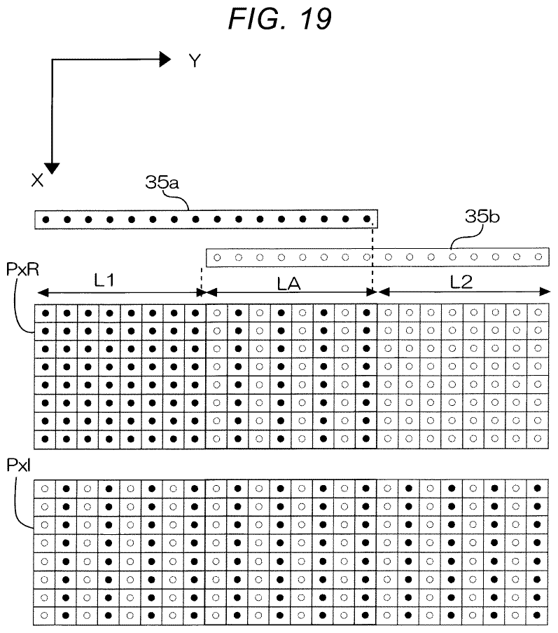

In the first embodiment, the first pixel group and the second pixel group are described as having dots formed alternately every other raster in the mixture area LA, but the formation of dots in the mixture area LA is not limited to the alternating pattern on every other raster and may be any pattern. For example, as shown in FIG. 19, dots may be formed alternately every other column by the first nozzle unit 35a and the second nozzle unit 35b. In the illustration, a bottom section PxI shows the state where a plurality of pixels forming an image are virtually divided into a first pixel group and a second pixel group in which dots are formed alternately every other column, and a middle section PxR shows which of the nozzles actually forms dots. As illustrated, in the area L1, dots are formed only by the first nozzle unit 35a, and in the area L2, dots are formed only by the second nozzle unit 35b, and in the mixture area LA, dots are formed by the first nozzle unit 35a and the second nozzle unit 35b. In this case, the partial dither masks M1 and M2 used in the halftone processing have characteristics such as the blue noise characteristic for each virtual pixel group in the bottom section PxI, and the characteristics thereof are generated without being correlated with each other. In the description below, the reference signs L1, L2, PxI and the like are used in the same meaning as in the above description.

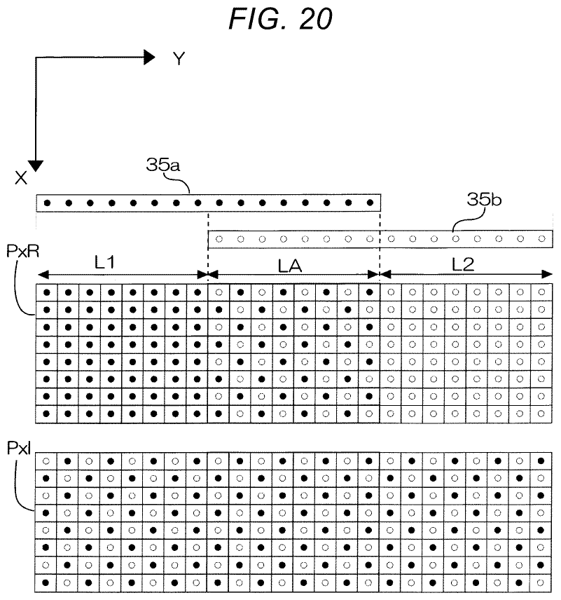

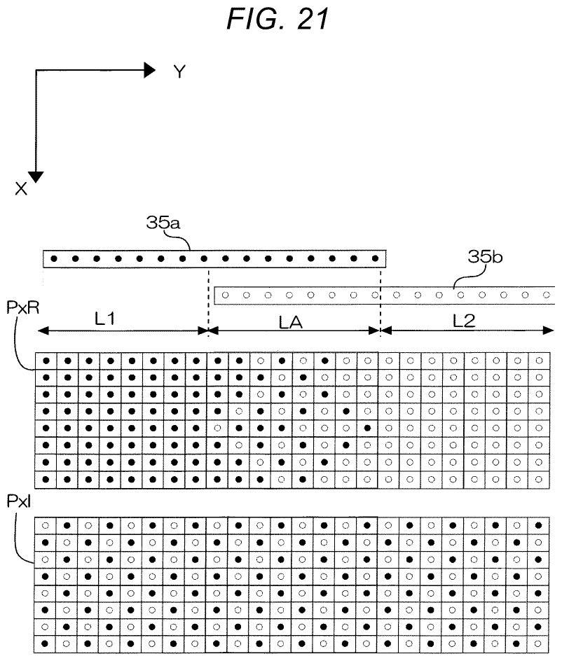

In addition, as shown in FIG. 20, the arrangement of the pixel groups in the mixture area LA may have a configuration of a checkered pattern using both the alternating pattern in every other column and the alternating pattern on every other raster. Also, as shown in FIG. 21, the mixture area LA may have a checkered pattern and a pattern in which the rate at which dots are formed in the other pixel group at both ends of the mixture area LA may be gradually decreased or gradually increased, or the like.

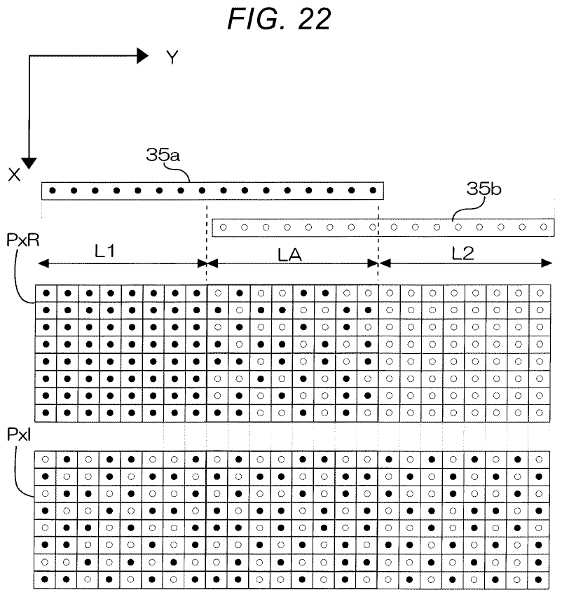

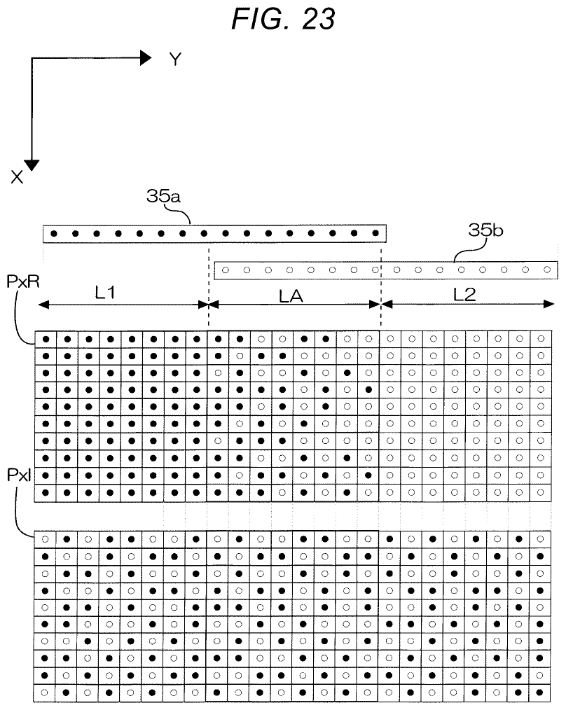

Alternatively, as shown in FIG. 22, the division into the first pixel group and the second pixel group may be performed in a random pattern. In FIG. 22, the pixels are divided into the first pixel group and the second pixel group alternately from a small value in the order of thresholds at which blue noise is generated, and the pixels where a dot is formed in the mixture area is in a random pattern. Also, FIG. 23 shows a pattern in which the rate at which dots are formed in the other pixel group in the mixture area LA is gradually decreased and gradually increased.

Any of these division methods is similar to the first embodiment in that the difference in the granularity and the coverage rate of dots between the mixture area LA, where dots formed by a plurality of different nozzle units coexist, and the areas L1 and L2, where dots are formed by a single nozzle unit, can be reduced, and that the quality of the printed image can be maintained at a level sufficiently high for practical use.

### C. Third Embodiment

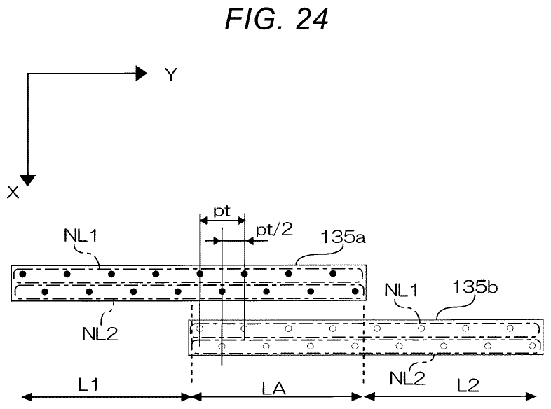

In each of the above-described embodiments, the arrangement of the nozzles that form dots is one row parallel to the raster in each of the first nozzle unit 35a and the second nozzle unit 35b, but the arrangement of the nozzles may be two rows in each of a first nozzle unit 135a and a second nozzle unit 135b, as shown in FIG. 24. In this case, the nozzles in one nozzle row NL1 may be shifted from the nozzles in the other nozzle row NL2 by half the nozzle pitch pt in the arrangement direction (Y direction) of the nozzle rows. When the nozzle rows are in a staggered arrangement, the shift between the nozzle row NL1 and the nozzle row NL2 in the staggered arrangement is smaller than the shift between the first nozzle unit 135a and the second nozzle unit 135b and therefore the positional shift due to the staggered arrangement is ignored. However, when the first nozzle unit 135a and the second nozzle unit 135b arranged in a staggered manner are used and the alternating pattern in every other column is employed in the mixture area LA, the area where the pixel groups are virtually divided from the pixel groups coincides with the division of each of the nozzle rows NL1 and NL2 and therefore the division from the pixel groups may be performed in consideration of both of the nozzle rows NL1 and NL2, without ignoring the shift between the nozzle rows NL1 and NL2.

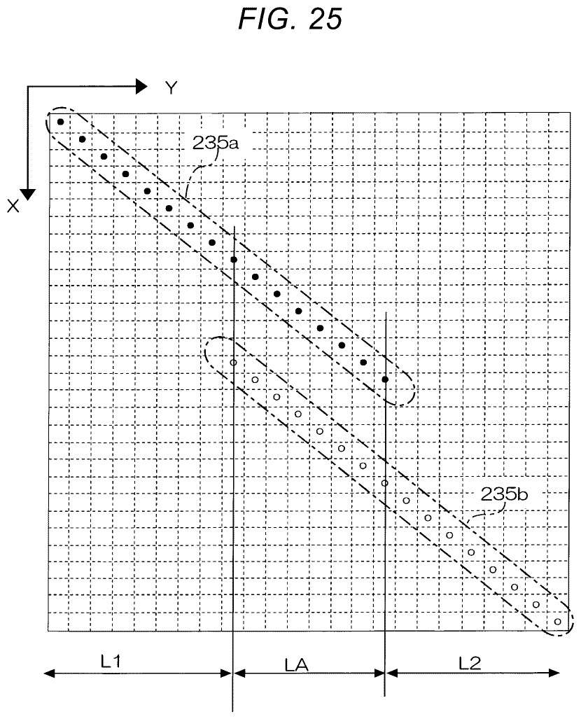

The nozzles provided in one row in the first nozzle unit 35a are provided in a direction coinciding with the raster direction in the first embodiment and the like, but may be provided obliquely in relation to the raster direction, as shown in FIG. 25. In this example, each of the first nozzle unit 135a and the second nozzle unit 135b is provided, inclined at 45 degrees in relation to the direction in which the raster is formed (Y direction). When the first nozzle unit 135a and the second nozzle unit 135b are formed obliquely, the dot pitch at which the rasters are formed can be made narrower than the processing pitch of the nozzles formed in the nozzle units. Also, since the formation timings of adjacent dots on the same raster can be made different from each other, when dots are formed using liquid droplets, the probability of the liquid droplets coming into contact with each other, resulting in color mixture, can be suppressed.

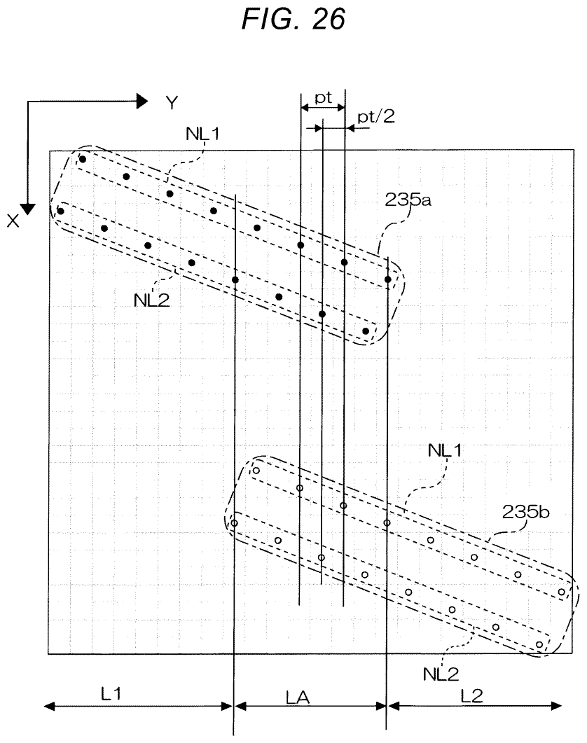

Also, as shown in FIG. 26, two or more oblique nozzle rows NI1 and NI2 may be provided in each of a first nozzle unit 235a and a second nozzle unit 235b. In this case, the pitch of the dots to be formed in the raster direction can be made finer. Any of these cases is similar to the first and second embodiments in that two nozzle units are used to form dots in the mixture area LA, whereas one nozzle unit is used in the areas L1 and L2, and that the variation in the granularity and the coverage rate for each area in this case can be reduced and the deterioration in the image quality can thus be suppressed.

### D. Fourth Embodiment

A fourth embodiment is different from the above-described embodiments in the method of generating the dither mask. In the fourth embodiment, the dither mask evaluation processing illustrated in FIG. 11 is performed only for the first pixel group, and the generated partial dither mask M1 is shifted and the partial dither mask M2 to be applied to the second pixel group is thus generated. This is because if the dither mask is shifted vertically and horizontally by a sufficient number of pixels, there is no correlation between the characteristics of the two dither masks. In this way, the partial dither mask can be easily generated. Even in the ejection unit 35 having any of the configurations in the first to third embodiments, an image can be formed by applying the generated dither mask.

### E. Other Embodiments

(1) In addition to the above, the present disclosure can be implemented as an image forming device that forms an output image corresponding to an original image. The image forming device includes: a halftone processing unit that determines an on and off of dot formation in accordance with an input tone value of the original image to be formed; and a dot forming unit that forms an output image including a plurality of pixels, with the dot, using a result of processing performed by the halftone processing unit, wherein the output image includes a first pixel group including a plurality of pixels whose positions in the output image are determined, and a second pixel group including a plurality of pixels arranged at different positions from the pixels of the first pixel group, the halftone processing unit causes an arrangement of pixels where dots are formed in the first pixel group to have a distribution having a first characteristic relating to dispersibility, causes an arrangement of pixels where dots are formed in the second pixel group to have a distribution having a second characteristic relating to dispersibility, and causes the distribution according second characteristic not to be correlated with the distribution according to the first characteristic when the input tone value of the original image is equal to or higher than a predetermined intermediate value, and the halftone processing unit determines the on and off of the dot in the arrangement having the first characteristic in the first pixel group, and determines the on and off of the dot in the arrangement having the second characteristic in the second pixel group.

In the image forming device, when the on and off of the dot is determined in the arrangement having the first characteristic in the first pixel group and the on and off of the dot is determined in the arrangement having the second characteristic in the second pixel group, the distribution of the dots according to the second characteristic related to the dispersibility of the dots is not correlated with the distribution of the dots according to the first characteristic when the input tone value of the original image is equal to or higher than the predetermined intermediate value. Therefore, even if there is a difference in the shift in the forming position between the dots formed corresponding to the first pixel group and the dots formed corresponding to the second pixel group, at least in a part of the output image, the change in the image quality due to the difference in the shift in the forming position is suppressed.

The halftone processing unit may be provided on the side of a device that directly forms dots, such as a printer or a display, or may be provided on the side of an image pickup device such as a computer or a camera, and may output the result of the halftone processing in the form of dot data indicating the on and off of dot formation, to the device. Alternatively, the halftone processing may be performed by a rasterizer or the like provided between a computer that outputs the original image and the printing device.

The on and off of the dot formation determined by the halftone processing unit includes not only binary changes in state such as whether to provide a liquid droplet or whether to turn on or off a light-emitting cell of an LED, in the case of the printing device, but also multi-value conversion including the formation of dots having different sizes such as small, medium, and large dots, and multi-value conversion including the formation of a light-colored dot, in the case of the liquid droplet. The light-colored ink may include light-magenta and light-cyan inks. When the image forming device is a display, the on and off includes switching the transmittance of the liquid crystal cell by the number of tones smaller than the input tone value of the original image.

The dot forming unit may only need to be able to express the on and off of the dots for each pixel, and when liquid droplets are used, any ejection technique and any size of the liquid droplets may be used. Also, the ink forming the liquid droplets may have any hue and brightness. The dot forming unit may directly form dots on a medium such as a printing paper, or may form dots temporarily on a transfer paper or the like and transfer the dots onto a medium. As long as dots can be formed, a thermal paper may be used, or a stencil may be used and dots corresponding to holes formed in the stencil may be formed on the medium. In the case of a display, dots may be formed by turning on and off a liquid crystal cell disposed in front of a light source, or by turning on and off an LED or an organic EL, which is a light source. If the display is a projector, dots may be formed by turning on and off dots in a liquid crystal shutter combined with a light valve, or by turning on and off micromirrors forming a digital mirror device.

(2) In the above configuration, when a separation distance between a first pixel, which is a pixel selected from the first pixel group, and a second pixel, which is a pixel selected from the second pixel group, is shorter than a predetermined threshold, a probability of dots being simultaneously formed at a pair of the first pixel and the second pixel may be approximated to a value determined corresponding to a square of the input tone value. Thus, even if there is a difference in the shift in the forming position between the dots formed corresponding to the first pixel group and the dots formed corresponding to the second pixel group, at least in a part of the output image, the change in the overlap of the formed dots is suppressed and the difference in the uneven density of the image is suppressed. The method of approximating the probability of dots being simultaneously formed at the pair of the first pixel and the second pixel to the value determined corresponding to the square of the input tone value is disclosed in JP-A-2012-204939 or the like and is a known technique, and therefore the detailed description thereof is omitted. Also, when the halftone processing unit performs the halftone processing using the dithering method, if a dither mask having the first characteristic for the first pixel group and a dither mask having the second characteristic for the second pixel group are separately generated and the distribution according to the second characteristic does not have a correlation with the distribution according to the first characteristic when the input tone value of the original image is equal to or higher than a predetermined intermediate value, the probability of dots being simultaneously formed at the pair of the first pixel and the second pixel can be approximated to the value determined in correspondence with the square of the input tone value when the above relationship holds, that is, when the separation distance between the first pixel, which is the pixel selected from the first pixel group, and the second pixel, which is the pixel selected from the second pixel group, is shorter than the predetermined threshold. Such dither masks can be easily prepared by first generating the dither mask for the first pixel group and shifting this dither mask by a sufficient distance both vertically and horizontally and thus generating the dither mask for the second pixel group. The sufficient distance may be approximately half the size of the dither mask.

(3) In the above configuration, each of the first characteristic and the second characteristic may be one of a blue noise characteristic and a green noise characteristic. Thus, the dispersibility of the arrangement of the dots can be increased, and in particular, the dispersibility in a frequency range where the sensitivity of the human eye is high can be increased, and therefore the granularity of the output image can be lowered and the quality of the image can be enhanced. Also, other characteristics such as a pink noise characteristic may be employed if the advantages in relation to the characteristics of the human eye are not taken into consideration.

(4) In the configurations of (1) to (3), the first pixel group and the second pixel group may include pixels corresponding to each of areas formed by dividing the output image in one of an alternating pattern on every other raster, an alternating pattern in every other column, and a checkered pattern. Thus, the ratio of the dots formed to belong to the first pixel group and the dots formed to belong to the second pixel group can be made close to even, at least in a part of the output image. The division pattern does not need to be the alternating pattern for each pixel, and may be an alternating pattern for every two pixels as a unit, or may be a division in which dots are not alternately arranged, as described below.

(5) In the configurations of (1) to (3), each of the first pixel group and the second pixel group may discontinuously include pixels at positions where dots are formed in order in accordance with one of a white noise characteristic, a blue noise characteristic, and a green noise characteristic, as the input tone value of the output image increases monotonically. Thus, a specific pattern is less likely to be generated in the arrangement of the pixels belonging to the first pixel group and the pixels belonging to the second pixel group, and therefore the drop in the image quality is suppressed further.

(6) In the configurations of (1) to (5), the image forming device may be a printing device in which the dot forming unit forms dots on a medium where the output image is formed, or a display that forms dots on a medium where the output image is formed, with a higher brightness than the medium. In the case of the printing device, the printing device is not limited to a printing device in which an ink or the like having a lower brightness than the medium is ejected onto the medium to form dots, and may also include a configuration in which an ink having a higher brightness than the medium is ejected, or a configuration in which a chemical solution to be ejected onto the medium before the ejection of an ink so as to improve the permeability of the ink on the medium surface or a chemical solution for covering or hardening an ink for image formation after the ejection of the ink is ejected, or the like, if the color of the medium is not white. Since such a chemical solution or the like, too, is related to the formation of the output image and therefore is included in the configuration to form the output image by dots.

The printing device is not limited to such an inkjet printer that performs printing by ejecting ink droplets and a chemical solution from a nozzle, and various configurations such as a thermal-transfer printer or a stencil printing device as long as the printing device reproduces a multi-tone original image by a distribution of dots can be applied. Also, regardless of the printing format, a serial printer that forms an image by moving a head that forms dots, forward and backward in the width direction of the medium, a line printer in which dot forming elements such as nozzles that form dots are arranged along the width direction of the medium, and a page printer that prepares a dot arrangement of an image for one page by a stencil, or the like, can be applied. The configuration of the image forming device is not limited to a printing device such as a printer, and may also be applied to a device that forms an image by turning on and off each pixel, such as an LED, an organic EL display, and a liquid crystal display.

(7) In the configurations of (1) to (6), the dot forming unit may include a first dot forming unit that forms a dot in a first part that is a part of the output image, and a second dot forming unit that forms a dot in a second part that is a part of the output image and includes an image area partly overlapping the first part, and in the image area that is a part of the output image, a dot formed by the first dot forming unit and a dot formed by the second dot forming unit coexist, and in an area excluding the image area of the output image, a dot is formed without using one of the first dot forming unit and the second dot forming unit. Thus, even if the shift in the dot forming position caused by the attachment accuracy of the first dot forming unit and the second dot forming unit changes, the change in the total dot dispersibility is suppressed and the drop in the image quality is also suppressed. Moreover, in many cases, the change in the state of overlap between dots is also suppressed and the occurrence of uneven density of the image is also suppressed.

(8) In the configurations of (1) to (7), the first pixel group and the second pixel group included in the output image may be formed by a division according to a factor that causes a shift in the forming position of the dot corresponding to the pixel position. For example, when the shift in the forming positions of the dots corresponding to the first pixel group and the second pixel group occurs in the arrangement direction of the nozzles of the ejection units such as the nozzle rows corresponding to the first pixel group and the second pixel group, that is, in the raster direction in which the dots are formed, the first pixel group and the second pixel group may be divided in the alternating raster pattern, and when the shift in the forming positions of the dots occurs In the raster direction in which the dots are formed in a direction perpendicular to the raster direction, they can be divided in the alternating pattern in every other column, and when the shift occurs in both directions, the pixels may be divided in the checkered pattern. Thus, the change in the image quality due to the difference in the shift in the forming position is suppressed further.

(9) In the configurations of (1) to (8), when the shift in the forming position of the dots by the first dot forming unit and the second dot forming unit is equal to or less than a predetermined threshold, the arrangement of the first pixel group and the second pixel group in the image area may be any arrangement. Thus, the degree of freedom in the arrangement of the pixel groups can be increased.

(10) In the configurations of (1) to (9), when there are a plurality of factors that cause a shift in the forming position of the dots by the first dot forming unit and the second dot forming unit, the arrangement of the first pixel group and the second pixel group in the image area may be determined according to a factor that causes a large shift. Thus, the shift in the forming position of the dots can be dealt with in response to the factor that causes a large shift, and therefore the deterioration in the image quality can be suppressed efficiently.

(11) In the above configuration, the dot forming unit may be provided in a dot forming head that can move relatively to a width direction of a medium on which the output image is formed, as a main scanning direction, when forming the dot, and the first dot forming unit may form dots in a first scan in the main scanning direction, and the second dot forming unit may form dots in a second scan different from the first scan. Thus, the change in the shift in the dot forming position generated by the first scan and the second scan can be dealt with.

(12) In the above configuration, the first scan and the second scan may be scans during a forward movement and a backward movement of the dot forming head in relation to the medium that is performed without a movement of the dot forming head in a sub-scanning direction, or two scans of a plurality of scans of the dot forming head in relation to the medium that is performed with a movement of the dot forming head in the sub scanning direction. Thus, the change in the dispersibility and the deterioration in the image quality due to the change in the shift in the image forming position can be suppressed even in bidirectional printing in which dots are formed in each of the forward movement and the backward movement of the dot forming head and in interlaced printing in which rasters in a plurality of main scans are combined while the dot forming head is shifted by a predetermined number of dots each, so as to complete an image, or the like.

(13) In the above configuration, the first dot forming unit and the second dot forming unit may include a plurality of dot forming elements for forming dots along a predetermined direction, may be arranged at overlapping positions such that end parts thereof overlap each other in a direction intersecting the predetermined direction in which the dot forming elements are arranged, and may form the dots at the pixels of the image area by the dot forming elements arranged at the overlapping positions. Thus, the change in the dispersibility between the state where there is a shift in the dot forming position generated at the overlapping positions and the state where there is no shift in the dot forming position that occurs in the non-overlapping area is suppressed, and the deterioration in the image quality can be suppressed.

(14) The present disclosure can also be implemented as an image forming method of forming an output image based on a distribution of dots. In the image forming method, the output image includes a first pixel group including a plurality of pixels whose positions are determined in the output image, and a second pixel group including a plurality of pixels arranged at positions different from the pixels of the first pixel group. The image forming method includes, in halftone processing of determining an on and off of dot formation in accordance with an input tone value of the original image to be formed: causing an arrangement of pixels where dots are formed in the first pixel group to have a distribution having a first characteristic relating to dispersibility; causing an arrangement of pixels where dots are formed in the second pixel group to have a distribution having a second characteristic relating to dispersibility, and causing the distribution according to the second characteristic not to be correlated with the distribution according to the first characteristic when the input tone value of the original image is equal to or higher than a predetermined intermediate value; determining the on and off of the dot in the arrangement having the first characteristic in the first pixel group, and determining the on and off of the dot in the arrangement having the second characteristic in the second pixel group; and forming an output image including a plurality of pixels, with the dot, using a result of the halftone processing.

In the image forming method, when the on and off of the dot is determined in the arrangement having the first characteristic in the first pixel group and the on and off of the dot is determined in the arrangement having the second characteristic in the second pixel group, the distribution of the dots according to the second characteristic related to the dispersibility of the dots is not correlated with the distribution of the dots according to the first characteristic when the input tone value of the original image is equal to or higher than the predetermined intermediate value. Therefore, even if there is a difference in the shift in the forming position between the dots formed corresponding to the first pixel group and the dots formed corresponding to the second pixel group, at least in a part of the output image, the change in the image quality due to the difference in the shift in the forming position is suppressed.

(15) The present disclosure may be implemented as an image processing device that processes an original image expressed with multiple tones into an output image expressed by a distribution of dots. In the image processing device, the output image includes a first pixel group including a plurality of pixels whose positions are determined in the output image, and a second pixel group including a plurality of pixels arranged at positions different from the pixels of the first pixel group, and in halftone processing of determining an on and off of dot formation in accordance with an input tone value of the original image, an arrangement of pixels where dots are formed in the first pixel group is made to have a distribution having a first characteristic relating to dispersibility, an arrangement of pixels where dots are formed in the second pixel group is made to have a distribution having a second characteristic relating to dispersibility and the distribution according to the second characteristic is not to be correlated with the distribution according to the first characteristic when the input tone value of the original image is equal to or higher than a predetermined intermediate value, the on and off of the dot in the arrangement having the first characteristic in the first pixel group is determined, and the on and off of the dot in the arrangement having the second characteristic in the second pixel group is determined.

In this image processing device, when the on and off of the dots is determined by the arrangement having the first characteristic in the first pixel group and the on and off of the dot is determined by the arrangement having the second characteristic in the second pixel group, the distribution of the dots according to the second characteristic relating to the dispersibility of the dots is not correlated with the distribution of the dots according to the first characteristic when the input tone value of the original image is equal to or more than the predetermined intermediate value. Therefore, when dots are formed based on the output image expressed by the dot distribution after the halftone processing, even if there is a difference in the shift in the forming positions of the dots formed corresponding to the first pixel group and the dots formed corresponding to the second pixel group, at least in a part of the output image, the change in the image quality due to the difference in the shift in the forming position is suppressed.

(16) Also, an image processing method corresponding to the image processing device achieves similar advantageous effects.

(17) In the above-described embodiments, a part of the configuration implemented by hardware may be replaced with software. At least a part of the configuration implemented by software can be implemented by a discrete circuit configuration. When a part or all of the functions according to the present disclosure are implemented by software, the software (computer program) can be provided in the form of being stored in a computer-readable recording medium. The “computer-readable recording medium” is not limited to a portable recording medium such as a flexible disc or a CD-ROM, and includes internal storage devices in a computer such as various RAMs and ROMs or an external storage device fixed to a computer such as a hard disk. That is, the term “computer-readable recording medium” has a broad meaning including any recording medium in which a data packet can be fixed, not temporarily.

The present disclosure is not limited to the above embodiments and may be implemented with various configurations without departing from the spirit and scope of the present disclosure. For example, technical features in the embodiments corresponding to technical features in the aspects described in the summary section can be replaced and combined as appropriate in order to solve a part or all of the above problems or in order to achieve a part or all of the above effects. Also, the technical features can be deleted as appropriate, unless described as essential in the present specification.

What is claimed is:

1. An image forming device that forms an output image corresponding to an original image, the image forming device comprising:
a halftone processing unit that determines an on and off of dot formation in accordance with an input tone value of the original image to be formed; and
a dot forming unit that forms an output image including a plurality of pixels, with the dot, using a result of processing performed by the halftone processing unit, wherein
the output image includes a first pixel group including a plurality of pixels whose positions in the output image are determined, and a second pixel group including a plurality of pixels arranged at different positions from the pixels of the first pixel group,
the halftone processing unit
causes an arrangement of pixels where dots are formed in the first pixel group to have a distribution having a first characteristic relating to dispersibility,
causes an arrangement of pixels where dots are formed in the second pixel group to have a distribution having a second characteristic relating to dispersibility, and causes the distribution according to the second characteristic not to be correlated with the distribution according to the first characteristic when the input tone value of the original image is equal to or higher than a predetermined intermediate value, and
determines the on and off of the dot in the arrangement having the first characteristic in the first pixel group, and determines the on and off of the dot in the arrangement having the second characteristic in the second pixel group.

2. The image forming device according to claim 1, wherein when a separation distance between a first pixel, which is a pixel selected from the first pixel group, and a second pixel, which is a pixel selected from the second pixel group, is shorter than a predetermined threshold, a probability of dots being simultaneously formed at a pair of the first pixel and the second pixel is approximated to a value determined corresponding to a square of the input tone value.

3. The image forming device according to claim 1, wherein each of the first characteristic and the second characteristic is one of a blue noise characteristic and a green noise characteristic.

4. The image forming device according to claim 1, wherein the first pixel group and the second pixel group include pixels corresponding to each of areas formed by dividing the output image in one of an alternating pattern on every other raster, an alternating pattern in every other column, and a checkered pattern.

5. The image forming device according to claim 1, wherein each of the first pixel group and the second pixel group discontinuously includes pixels at positions where dots are formed in order in accordance with one of a white noise characteristic, a blue noise characteristic, and a green noise characteristic, as the input tone value of the output image increases monotonically.

6. The image forming device according to claim 1, wherein the first pixel group and the second pixel group included in the output image are formed by a division according to a factor that causes a shift in the forming position of the dot corresponding to the pixel position.

7. The image forming device according to claim 1, wherein
the image forming device is
a printing device in which the dot forming unit forms dots on a medium where the output image is formed, or
a display that forms dots on a medium where the output image is formed, with a higher brightness than the medium.

8. The image forming device according to claim 1, wherein
the dot forming unit includes a first dot forming unit that forms a dot in a first part that is a part of the output image, and a second dot forming unit that forms a dot in a second part that is a part of the output image and includes an image area partly overlapping the first part,
in the image area that is a part of the output image, a dot formed by the first dot forming unit and a dot formed by the second dot forming unit coexist, and
in an area excluding the image area of the output image, a dot is formed without using one of the first dot forming unit and the second dot forming unit.

9. The image forming device according to claim 8, wherein the first pixel group and the second pixel group included in the output image are formed by a division according to a factor that causes a shift in the forming position of the dot corresponding to the pixel position.

10. The image forming device according to claim 9, wherein when the shift in the forming position of the dots by the first dot forming unit and the second dot forming unit is equal to or less than a predetermined threshold, the arrangement of the first pixel group and the second pixel group in the image area is any arrangement.

11. The image forming device according to claim 9, wherein when there are a plurality of factors that cause a shift in the forming position of the dots by the first dot forming unit and the second dot forming unit, the arrangement of the first pixel group and the second pixel group in the image area is determined according to a factor that causes a large shift.

12. The image forming device according to claim 8, wherein
the dot forming unit is provided in a dot forming head that can move relatively to a width direction of a medium on which the output image is formed, as a main scanning direction, when forming the dot,
the first dot forming unit forms dots in a first scan in the main scanning direction, and
the second dot forming unit forms dots in a second scan different from the first scan.

13. The image forming device according to claim 12, wherein
the first scan and the second scan are scans during a forward movement and a backward movement of the dot forming head in relation to the medium that is performed without a movement of the dot forming head in a sub scanning direction, or
two scans of a plurality of scans of the dot forming head in relation to the medium that is performed with a movement of the dot forming head in the sub-scanning direction.

14. The image forming device according to claim 8, wherein
the first dot forming unit and the second dot forming unit
include a plurality of dot forming elements for forming dots along a predetermined direction,
are arranged at overlapping positions such that end parts thereof overlap each other in a direction intersecting the predetermined direction in which the dot forming elements are arranged, and
form the dots at the pixels in the image area by the dot forming elements arranged at the overlapping positions.

15. An image forming method of forming an output image based on a distribution of dots,
the output image including a first pixel group including a plurality of pixels whose positions are determined in the output image, and a second pixel group including a plurality of pixels arranged at positions different from the pixels of the first pixel group,
the image forming method comprising, in halftone processing of determining an on and off of dot formation in accordance with an input tone value of the original image to be formed:
causing an arrangement of pixels where dots are formed in the first pixel group to have a distribution having a first characteristic relating to dispersibility;
causing an arrangement of pixels where dots are formed in the second pixel group to have a distribution having a second characteristic relating to dispersibility, and causing the distribution according to the second characteristic not to be correlated with the distribution according to the first characteristic when the input tone value of the original image is equal to or higher than a predetermined intermediate value;
determining the on and off of the dot in the arrangement having the first characteristic in the first pixel group, and determining the on and off of the dot in the arrangement having the second characteristic in the second pixel group; and
forming an output image including a plurality of pixels, with the dot, using a result of the halftone processing.

16. An image processing device that processes an original image expressed with multiple tones into an output image expressed by a distribution of dots,
the output image including a first pixel group including a plurality of pixels whose positions are determined in the output image, and a second pixel group including a plurality of pixels arranged at positions different from the pixels of the first pixel group, wherein
in halftone processing of determining an on and off of dot formation in accordance with an input tone value of the original image,
an arrangement of pixels where dots are formed in the first pixel group is made to have a distribution having a first characteristic relating to dispersibility,
an arrangement of pixels where dots are formed in the second pixel group is made to have a distribution having a second characteristic relating to dispersibility and the distribution according to the second characteristic is not correlated with the distribution according to the first characteristic when the input tone value of the original image is equal to or higher than a predetermined intermediate value, and
the on and off of the dot in the arrangement having the first characteristic in the first pixel group is determined, and the on and off of the dot in the arrangement having the second characteristic in the second pixel group is determined.

17. An image processing method in which an original image expressed with multiple tones is processed into an output image expressed by a distribution of dots,
the output image including a first pixel group including a plurality of pixels whose positions are determined in the output image, and a second pixel group including a plurality of pixels arranged at positions different from the pixels of the first pixel group,
the image processing method comprising, in halftone processing of determining an on and off of dot formation in accordance with an input tone value of the original image;
causing an arrangement of pixels where dots are formed in the first pixel group to have a distribution having a first characteristic relating to dispersibility,
causing an arrangement of pixels where dots are formed in the second pixel group to have a distribution having a second characteristic relating to dispersibility, and causing the distribution according to the second characteristic not to be correlated with the distribution according to the first characteristic when the input tone value of the original image is equal to or higher than a predetermined intermediate value, and
determining the on and off of the dot in the arrangement having the first characteristic in the first pixel group, and determining the on and off of the dot in the arrangement having the second characteristic in the second pixel group.
